(19) United States
(12) Patent Application Publication
(10) Pub. No.: US 2015/0169116 A1
(43) Pub. Date: Jun. 18, 2015

(54) TOUCH PANEL AND DISPLAY DEVICE

(71) Applicant: Sharp Kabushiki Kaisha, Osaka-shi, Osaka (JP)

(72) Inventor: Takeshi Masuda, Osaka-shi (JP)

(21) Appl. No.: 14/408,381

(22) PCT Filed: Jul. 24, 2013
(86) PCT No.: PCT/JP2013/070053

§ 371 Date: Dec. 16, 2014

(30) Foreign Application Priority Data
Aug. 6, 2012 (JP) 2012-174189

(51) Int. Cl. G06F 3/047; G06F 3/044

(52) U.S. Cl. CPC G06F 3/047; G06F 3/044; G09G 2300/0426

(57) ABSTRACT

A touch panel (10) is provided with an X electrode (2) and a Y electrode (4) in which unit electrodes (2w and 4w), which are configured by a plurality of rectangular small grids (2u and 4u) formed by wiring (6) formed of fine metal wires, are electrically connected in a predetermined direction. Therefore, it is possible to provide a touch panel capable of suppressing visibility of a light-dark pattern and a mesh-like small grid, even if variations occur in the patterning processes of touch panel electrodes.

### TECHNICAL FIELD

The present invention relates to a touch panel and a display device provided with a touch panel.

### BACKGROUND ART

In recent years, in particular, in the field of portable devices such as smart phones and tablet PCs, display devices provided with a touch panel are popular. The touch panel embodies a function in which input means such as a finger or an input pen makes contact with a display surface, and a selection is made corresponding to the contact position.

Such display devices provided with a touch panel are increasingly being adopted in the fields of televisions, monitors and the like.

In the related art, resistive film type touch panel (a system which detects an input position due to an upper conductive substrate contacting a lower conductive substrate when pressed), and an electrostatic capacitive type touch panel (a system which detects the input position by detecting a capacitance change in the touched location) are mainly used as the touch panel provided in the display device.

Of these, the electrostatic capacitive touch panel is presently the mainstream type of touch panel because it is possible to detect the contact position using a simple operation, and because it is possible to support multi-touch (the simultaneous detection of a plurality of touch positions).

However, when the electrostatic capacitive touch panel electrodes are formed of a transparent electrode material such as indium tin oxide (ITO), which has a relatively high resistance, and applied to a relatively large display device such as a television or a monitor, there is a problem in that the propagation speed of current between the electrodes becomes low and the response speed, which is the time from a fingertip coming into contact until the position thereof is detected, becomes low.

Therefore, PTL 1 discloses a case in which the electrostatic capacitive touch panel electrodes are formed using fine metal wires formed of gold (Au), silver (Ag), or copper (Cu).

FIG. 25 are diagrams illustrating the schematic configuration of touch panel electrodes formed of fine metal wire disclosed in PTL 1.

FIG. 25(a) illustrates a first conductive sheet (X pattern electrode) 110A in which a plurality of first conductive patterns 122A, in which two or more first large grids 114A are arranged in an x direction via a first connecting portion 116A, are formed to be arranged in a y direction orthogonal to the x direction via a first insulating portion 124A. FIG. 25(b) illustrates a second conductive sheet (Y pattern electrode) 110B in which a plurality of second conductive patterns 122B, in which two or more second large grids 114B are arranged in the y direction via a second connecting portion 116B, are formed to be arranged in the x direction orthogonal to the y direction via a second insulating portion 124B.

As illustrated in the drawings, each of the first large grids 114A and the second large grids 114B that are formed of fine metal wires are configured by the repetition of a plurality of square small grids 118, and the first connecting portion 116A and the second connecting portion 116B are configured by disposing one or more medium grids 120a, 120b, 120c, and 120d which have a pitch n-times (where n is a real number greater than 1) the square small grids 118.

While not illustrated in the drawings, the first conductive sheet (the X pattern electrode) 110A and the second conductive sheet (the Y pattern electrode) 110B form the electrostatic capacitive touch panel electrodes by being laminated via an insulating layer so as to be disposed in the space portions of each other.

PTL 1 describes that the length of one side of the square small grid 118 is preferably 50 μm to 500 μm, and more preferably 150 μm to 300 μm, and that, when the length of one side of the square small grid 118 falls within the range described above, it is possible to achieve a reduction in the resistance of the electrostatic capacitive touch panel electrodes, it is possible to maintain favorable transparency, and it is possible to view the display without feeling discomfort when the touch panel is attached to the front surface of a display device.

### CITATIONS LIST

### Patent Literature

PTL 1: Japanese Unexamined Patent Application Publication No. 2011-129112 (laid open Jun. 30, 2011)

### SUMMARY OF INVENTION

### Technical Problem

Since the first conductive sheet (the X pattern electrode) 110A and the second conductive sheet (the Y pattern electrode) 110B provided in the electrostatic capacitive touch panel electrodes disclosed in PTL 1 are separate layers, they are formed through respective separate patterning processes; however, when the wiring width of the fine metal wires varies in the patterning processes, the aperture (the transmittance) differs between the first conductive sheet (the X pattern electrode) 110A and the second conductive sheet (the Y pattern electrode) 110B, and a light-dark pattern emerges.

In order to suppress the emergence of the light-dark pattern, it is conceivable to increase the length of one side of the square small grid 118 in the first conductive sheet (the X pattern electrode) 110A and the second conductive sheet (the Y pattern electrode) 110B; however, when the length of one side of the square small grid 118 is increased, the mesh-like wiring pattern becomes more visible, which is a problem.

In other words, in the electrostatic capacitive touch panel electrodes disclosed in PTL 1, since the emergence of the light-dark pattern and the visibility of the mesh-like wiring pattern are in a trade-off relationship, it is difficult to suppress both the emergence of the light-dark pattern and the visibility of the mesh-like wiring pattern.

Hereinafter, the reason for the emergence of the light-dark pattern, and the reason for the mesh-like wiring pattern becoming more visible will be described based on FIGS. 26 and 27.

FIG. 26(a) is a diagram illustrating the square small grid 118 in the electrostatic capacitive touch panel disclosed in PTL 1, and FIG. 26(b) is a diagram for describing that, when the same level of wiring width variation occurs in each patterning process of the first conductive sheet (the X pattern electrode) 110A and the second conductive sheet (the Y pattern electrode) 110B, it is possible to suppress the emergence of the light-dark pattern by increasing the length of one side of the square small grid 118.

FIG. 26(b) illustrates the change in the aperture (transmittance) of each of the pattern electrodes caused by the magnitude of the variation in the wiring width that occurs in the patterning processes between the first conductive sheet (the X pattern electrode) 110A and the second conductive sheet (the Y pattern electrode) 110B when the wiring width of the square small grid illustrated in FIG. 26(a) is set to 10 μm and one side of the square small grid is set to 500 μm.

When no variation occurs in the wiring width in the patterning processes between the first conductive sheet (the X pattern electrode) 110A and the second conductive sheet (the Y pattern electrode) 110B, and all the electrodes are formed at 10 μm, as designed, the difference in the aperture (the transmittance) is 0%, and the light-dark pattern is not visible at all.

Meanwhile, when variation of ±1 μm occurs in the wiring width in the patterning processes between the first conductive sheet (the X pattern electrode) 110A and the second conductive sheet (the Y pattern electrode) 110B, the difference in the aperture (the transmittance) is 0.81%, and when variation of ±2 μm occurs in the wiring width, the difference in the aperture (the transmittance) is 1.6%.

When there is a difference in the aperture (the transmittance) of the first conductive sheet (the X pattern electrode) 110A and the second conductive sheet (the Y pattern electrode) 110B, the light-dark pattern is visible; however, according to experimental data, the results that are obtained indicate that, when the difference in the aperture (the transmittance) of the first conductive sheet (the X pattern electrode) 110A and the second conductive sheet (the Y pattern electrode) 110B is less than or equal to 1%, the light-dark pattern is visible to a small degree without causing irritation, and when the difference is less than or equal to 0.5%, the light-dark pattern is not recognized.

Therefore, in a case where the wiring width of the square small grid is set to 10 μm and one side of the square small grid is set to 500 μm, when there is a variation of ±2 μm in the wiring width of the first conductive sheet (the X pattern electrode) 110A and the second conductive sheet (the Y pattern electrode) 110B, the light-dark pattern is observed in the touch panel electrodes, and when there is variation of ±1 μm in the wiring width, the light-dark pattern is visible to a small degree.

Since a variation of approximately ±2 μm normally occurs depending on conditions such as position and the start and end of the manufacturing in the patterning processes between the first conductive sheet (the X pattern electrode) 110A and the second conductive sheet (the Y pattern electrode) 110B, when a design is adopted in which the wiring width of the square small grid is set to 10 μm and one side of the square small grid is set to 500 μm, the emergence of the light-dark pattern cannot be avoided in mass production.

Therefore, in consideration of the problem of the light-dark pattern, when one side of the square small grid must be lengthened and one side of the square small grid is set to 810 μm, even if a variation of ±2 μm occurs in the wiring width in the patterning processes between the first conductive sheet (the X pattern electrode) 110A and the second conductive sheet (the Y pattern electrode) 110B, it is possible to set the difference in the aperture (transmittance) to less than or equal to 1%, and it is possible to achieve a degree of the light-dark pattern that poses no practical problems.

However, when one side of the square small grid is lengthened, in the touch panel electrodes, the mesh-like small grids themselves become visible for the reasons described below.

FIG. 27 is a diagram illustrating the relationship between the spatial frequency and the contrast sensitivity in a case where one side of the square small grid is 500 μm and in a case where one side of the square small grid is 810 μm.

In the drawings, the contrast sensitivity is (1/contrast threshold), and the spatial frequency is the number of stripes per 1 degree of visual angle.

According to the characteristics of human vision, a stripe pattern with 4 cycles in 1 degree of visual angle (4 cycle/deg) has the highest sensitivity, and when the visual distance during touch panel operation is assumed to be 300 mm, this corresponds to a stripe pattern with a cycle of 1.3 mm.

As illustrated in the drawings, when the length of one side of the square small grid is 810 μm, there are 6.46 (cycle/deg) at a visual distance of 300 mm, the contrast sensitivity is extremely high, and the mesh-like square small grid is visually obvious.

Meanwhile, when the length of one side of the square small grid is 500 μm, there are 10.5 (cycle/deg) at a visual distance of 300 mm, and while the contrast sensitivity decreases and the mesh-like square small grid is not visually obvious, the light-dark pattern described above is visible.

A problem is, as described above, in the electrostatic capacitive touch panel electrodes disclosed in PTL 1, it is not possible to solve both the problem of the light-dark pattern and the problem of the visibility of the mesh-like small grid.

The present invention was made in consideration of the problems described above, and an object thereof is to provide a touch panel and a display device that are capable of suppressing the visibility of the light-dark pattern and the mesh-like small grid, even if variations occur in the patterning processes of the touch panel electrodes.

### Solution to Problem

In order to solve the problems described above, a touch panel of the present invention includes a first electrode which is formed by a plurality of first electrode rows which are formed by a plurality of first unit electrodes including a plurality of grids formed by wiring formed of fine metal wires being connected in a first direction, the first electrode rows being arranged in a second direction orthogonal to the first direction at a predetermined interval; and a second electrode which is electrically isolated from the first electrode and is formed by a plurality of second electrode rows which are formed by a plurality of second unit electrodes including the plurality of grids being connected in the second direction, the second electrode rows being arranged in the first direction at a predetermined interval, in which the first electrode and the second electrode are disposed such that the electrodes of one of the first unit electrodes and the second unit electrodes are surrounded by the electrodes of the other in plan view, and in which a shape of the grid is formed such that a difference in transmittance between the plurality of grids is less than or equal to 1%, and, the wiring in the plurality of grids includes at least a portion formed at a first cycle interval and a portion formed at a second cycle interval that differs from the first cycle interval.

According to this configuration, the shape of the grid is formed such that the difference in the transmittance between the plurality of grids is less than or equal to 1%, and the wiring in the plurality of grids contains at least a portion formed at the first cycle interval and a portion formed at the second cycle interval that differs from the first cycle interval.

Therefore, in comparison to a cyclic grid pattern in which the wiring is formed repeatedly at a single same cycle in all directions, in this configuration, since at least a portion formed at the first cycle interval and a portion formed at the second cycle interval that differs from the first cycle interval are included, the cyclic pattern of the grids becomes less visible due to grids formed at two or more cycles being mixed together.

Therefore, it is possible to realize a touch panel capable of suppressing the visibility of the light-dark pattern and the mesh-like small grid, even if variations occur in the patterning processes of the touch panel electrodes.

A display device of the present invention is provided with the touch panel described above in order to solve the problems described above.

According to this configuration, it is possible to realize a display device capable of suppressing the visibility of the light-dark pattern and the mesh-like small grid, even if variations occur in the patterning processes of the touch panel electrodes.

### Advantageous Effects of Invention

As described above, the touch panel of the present invention is configured such that the first electrode and the second electrode are disposed such that the electrodes of one of the first unit electrodes and the second unit electrodes are surrounded by the electrodes of the other in plan view, and a shape of the grid is formed such that a difference in transmittance between the plurality of grids is less than or equal to 1%, and, the wiring in the plurality of grids includes at least a portion formed at a first cycle interval and a portion formed at a second cycle interval that differs from the first cycle interval.

The display device of the present invention is configured to be provided with the touch panel described above.

Therefore, it is possible to realize a touch panel and a display device that are capable of suppressing the visibility of the light-dark pattern and the mesh-like small grid, even if variations occur in the patterning processes of the touch panel electrodes.

### BRIEF DESCRIPTION OF DRAWINGS

FIG. 1 is a diagram illustrating a pattern of touch panel electrodes of a touch panel of a first embodiment of the present invention, as seen from a glass substrate side.

FIG. 2 is a diagram illustrating the schematic configuration the touch panel of the first embodiment of the present invention.

FIG. 3 are diagrams illustrating the schematic shape of an X electrode and a Y electrode provided in the touch panel of the first embodiment of the present invention.

FIG. 4 are diagrams in which a portion of the X electrode provided in the touch panel of the first embodiment of the present invention is enlarged.

FIG. 5 are diagrams for describing the reason that it is possible to suppress the visibility of a light-dark pattern and a mesh-like small grid in the touch panel of the first embodiment of the present invention.

FIG. 6 is a diagram illustrating a pattern of touch panel electrodes of the first embodiment of the present invention.

FIG. 7 are diagrams illustrating the schematic shape of an X electrode and a Y electrode provided in a touch panel of a second embodiment of the present invention.

FIG. 8 is a diagram illustrating a pattern of touch panel electrodes of a touch panel of the second embodiment of the present invention, as seen from a glass substrate side.

FIG. 9 are diagrams illustrating polygonal small grids used in the touch panel of the second embodiment of the present invention.

FIG. 10 are diagrams for describing the reason that it is possible to suppress the visibility of a light-dark pattern and a mesh-like small grid in the touch panel of the second embodiment of the present invention.

FIG. 11 is a diagram illustrating a pattern of touch panel electrodes of the second embodiment of the present invention.

FIG. 12 are diagrams illustrating the schematic shape of an X electrode and a Y electrode provided in a touch panel of a third embodiment of the present invention.

FIG. 13 is a diagram illustrating a pattern of touch panel electrodes of a touch panel of the third embodiment of the present invention, as seen from a glass substrate side.

FIG. 14(a) illustrates a case in which, in an intersecting portion of a connecting portion, an L-shaped hexagonal shape is apparent and the electrical connection between the unit electrodes of the Y electrode is a single path, and (b) is the configuration used in the touch panel of the third embodiment of the invention, and illustrates a case in which, in the intersecting portion of the connecting portion, a substantially L-shaped hexagonal shape is apparent and the electrical connection between the unit electrodes of the Y electrode is two paths.

FIG. 15 are diagrams illustrating the schematic shape of an X electrode and a Y electrode provided in a touch panel of a fourth embodiment of the present invention.

FIG. 16 is a diagram illustrating a pattern of touch panel electrodes of the touch panel of the fourth embodiment of the present invention, as seen from a glass substrate side.

FIG. 17 are diagrams illustrating polygonal small grids used in the touch panel of the fourth embodiment of the present invention.

FIG. 18 are diagrams for describing the reason that it is possible to suppress the visibility of a light-dark pattern and a mesh-like small grid in the touch panel of the fourth embodiment of the present invention.

FIG. 19 is a diagram illustrating a pattern of touch panel electrodes of the fourth embodiment of the present invention.

FIG. 20 are diagrams illustrating the schematic shape of an X electrode and a Y electrode provided in a touch panel of a fifth embodiment of the present invention.

FIG. 21 is a diagram illustrating a pattern of touch panel electrodes of a touch panel of the fifth embodiment of the present invention, as seen from a glass substrate side.

FIG. 22 are diagrams illustrating polygonal small grids used in the touch panel of the fifth embodiment of the present invention.

FIG. 23 are diagrams for describing the reason that it is possible to suppress the visibility of a light-dark pattern and a mesh-like small grid in the touch panel of the fifth embodiment of the present invention.

FIG. 24 is a diagram illustrating a pattern of touch panel electrodes of the fifth embodiment of the present invention.

FIG. 25 are diagrams illustrating the schematic configuration of touch panel electrodes formed of fine metal wire disclosed in PTL 1.

FIG. 26 are diagrams for describing the reason that the light-dark pattern is generated.

FIG. 27 is a diagram for describing the reason that the mesh-like wiring pattern becomes visible.

### DESCRIPTION OF EMBODIMENTS

Hereinafter, detailed description will be given of embodiments of the present invention based on the drawings. However, the dimensions, materials, shapes, relative disposition, and the like of the components described in the present embodiment are merely a single embodiment, and the scope of the present invention should not be interpreted to be limited thereby.

Note that, in the following embodiments, a liquid crystal display device is exemplified as a display device provided with touch panel electrodes; however, the invention is not limited thereto. For example, the display device naturally may be an organic EL display device or the like.

### [First Embodiment]

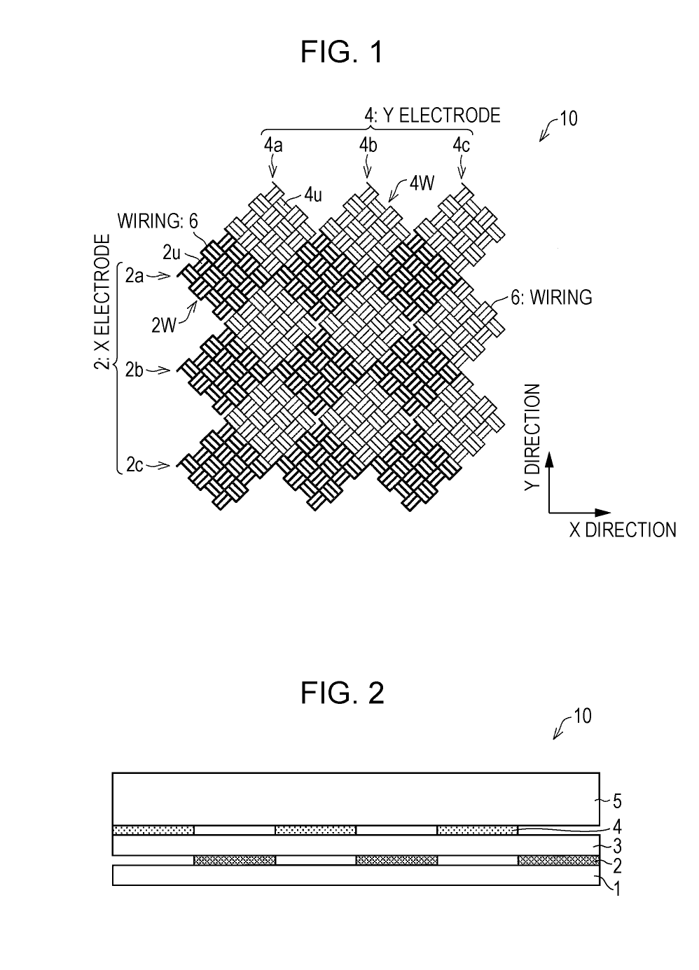

Hereinafter, description will be given of the first embodiment of the present invention based on FIGS. 1 to 6.

FIG. 2 is a diagram illustrating the schematic configuration of an electrostatic capacitive touch panel 10.

As illustrated in the drawing, the touch panel 10 is configured by a transparent film 3 and a transparent film 1 being laminated, in order, on the surface of the bottom side of a glass substrate 5. A Y electrode (the Y pattern electrode) 4 is formed on the transparent film 3, and an X electrode (the X pattern electrode) 2 is formed on the transparent film 1.

A transparent PET film, for example, can be used for the transparent films 1 and 3, and it is possible to form the X electrode 2 and the Y electrode 4 in a predetermined pattern by etching copper foil that is bonded onto a transparent PET film, etching silver that is formed using sputtering, printing silver paste onto a transparent PET film, or the like.

While detailed description will be given later, the predetermined patterns of the X electrode 2 and the Y electrode 4 are configured by wiring formed of fine metal wires, the material thereof is not particularly limited as long as the resistance value is low, and gold (Au) may be used in addition to copper (Cu) and silver (Ag).

Note that, when combining the touch panel 10 with a flexible display device or the like, it is preferable to use a flexible transparent substrate instead of the glass substrate 5.

It is not necessary to use a configuration in which the X electrode 2 and the Y electrode 4 are formed on a transparent film for the touch panel 10, and a configuration may be used in which one of either the X electrode 2 and the Y electrode 4 is formed on the glass substrate 5, the other of the X electrode 2 and the Y electrode 4 is formed via the insulating layer on the insulating layer, and a transparent protective film is subsequently formed thereon.

When combining the touch panel 10 with a liquid crystal display panel (not shown), it is possible to realize a liquid crystal display device provided with an on-cell touch panel by forming a color filter layer and the like on a surface of the glass substrate 5 on which the X electrode 2 and the Y electrode 4 are not formed, and using the glass substrate 5 as a color filter substrate.

Meanwhile, it is possible to realize a liquid crystal display device provided with an in-cell touch panel by using the glass substrate 5 as the color filter substrate and providing a TFT substrate on the side of a surface of the glass substrate 5 on which the X electrode 2 and the Y electrode 4 are formed such that the TFT substrate opposes the glass substrate 5.

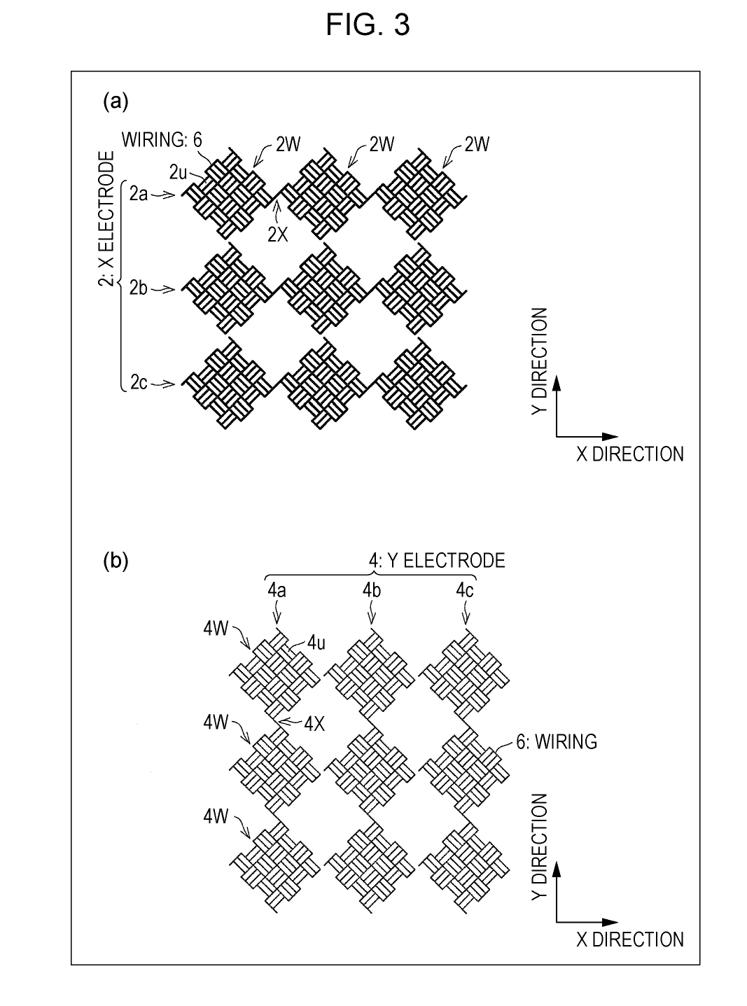

FIG. 3 are diagrams illustrating the schematic shapes of the X electrode 2 and the Y electrode 4 provided in the touch panel 10.

FIG. 3(a) illustrates the schematic shape of the X electrode 2, and the X electrode 2 is formed by electrodes 2a, 2b, 2c . . . being arranged in the Y direction in the drawing at a predetermined interval. The electrodes 2a, 2b, 2c . . . are formed by substantially square grid-shaped unit electrodes 2W being electrically connected to each other in the X direction in the drawing, and the unit electrodes 2W are formed of a plurality of rectangular small grids 2u, which are formed by the wirings 6 formed of fine metal wires.

Meanwhile, FIG. 3(b) illustrates the schematic shape of the Y electrode 4, and the Y electrode 4 is formed by electrodes 4a, 4b, 4c . . . being arranged in the X direction in the drawing at a predetermined interval. The electrodes 4a, 4b, 4c . . . are formed by substantially square grid-shaped unit electrodes 4W being electrically connected to each other in the Y direction in the drawing, and the unit electrodes 4W are formed of a plurality of rectangular small grids 4u, which are formed by the wirings 6 formed of fine metal wires.

FIG. 1 is a diagram illustrating the pattern of the touch panel electrodes formed of the X electrode 2 and the Y electrode 4 when the touch panel 10 is viewed from the glass substrate 5 side.

As illustrated in the drawing, the X electrode 2 and the Y electrode 4 form the touch panel electrodes by being laminated so as to be disposed in the space portions of each other via the transparent film 3 (not shown) as an insulating layer.

In other words, the touch panel electrodes are formed by, in plan view, the substantially square grid unit electrodes 2W in the X electrode 2 being disposed so as to be surrounded by the substantially square grid-shaped unit electrodes 4W in the Y electrode 4, while the substantially square grid unit electrodes 4W in the Y electrode 4 are disposed so as to be surrounded by the substantially square grid-shaped unit electrodes 2W in the X electrode 2.

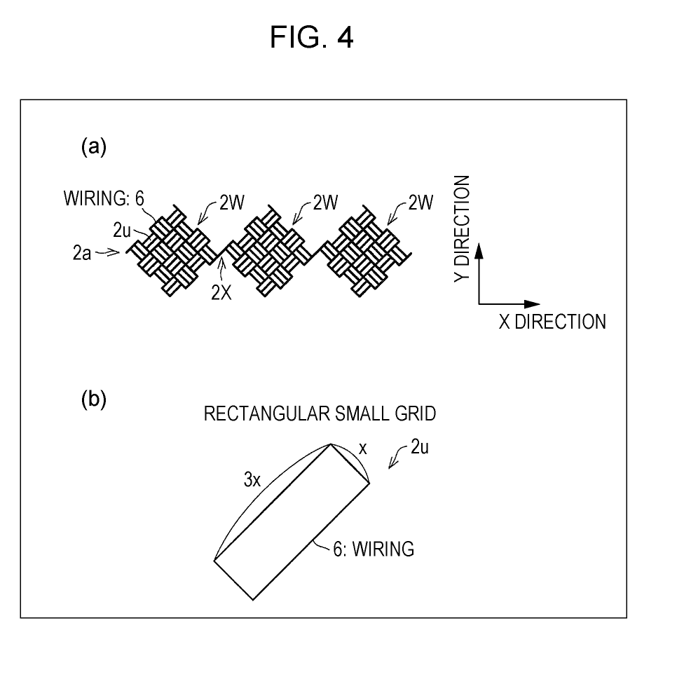

FIG. 4 are diagrams in which a portion of the X electrode 2 provided in the touch panel 10 is enlarged.

As illustrated in FIG. 4(a), the electrode 2a that configures the X electrode 2 is formed by a plurality of the substantially square grid-shaped unit electrodes 2W being electrically connected to each other, and the plurality of substantially square grid-shaped unit electrodes 2W are configured from a plurality of the rectangular small grids 2u illustrated in FIG. 4(b).

Note that, while omitted from the partial enlarged diagram, similarly for the Y electrode 4 provided in the touch panel 10, the electrode 4a that configures the Y electrode 4 is formed by a plurality of the substantially square grid-shaped unit electrodes 4W being electrically connected to each other, and the plurality of substantially square grid-shaped unit electrodes 4W are configured from a plurality of the rectangular small grids 4u similar to the plurality of the rectangular small grids 2u illustrated in FIG. 4(b).

In the rectangular small grids 2u and 4u, the wiring 6 is formed so as to include at least a portion formed at a first cycle interval, and a portion formed at a second cycle interval that differs from the first cycle interval, and in the present embodiment, the first cycle interval is 3x, and the second cycle interval is x.

When the wiring 6 is repeated at one cycle, the cyclic pattern of the small grid is clearly visible; however, by mixing two or more cycles, the mesh is chopped up and becomes less visible as a cyclic pattern of the small grid. Furthermore, if the two or more cycles are a combination of large and small by contrast sensitivity, the recognizability is alleviated.

In the present embodiment, as illustrated in FIG. 2, description is given of a case in which the X electrode 2 and the Y electrode 4 are formed as different layers; however, the configuration is not limited thereto. For example, it is possible to use a configuration in which the substantially square grid-shaped unit electrodes 2W in the X electrode 2 and the substantially square grid-shaped unit electrodes 4W in the Y electrode 4 are electrically isolated from each other, are formed on the same surface, and an insulating layer is provided between the connecting portions of the unit electrodes 2W and the connecting portions of the unit electrodes 4W which intersect each other.

As illustrated in FIG. 4(b), in the present embodiment, the ratio of the long side to the short side in the rectangular small grids 2u and 4u is 3:1.

Specifically, a design is adopted in which the wiring width of the wiring 6 formed of fine metal wire is 10 μm, and the long edges and the short edges of the rectangular small grids 2u and 4u are 1620 μm and 540 μm.

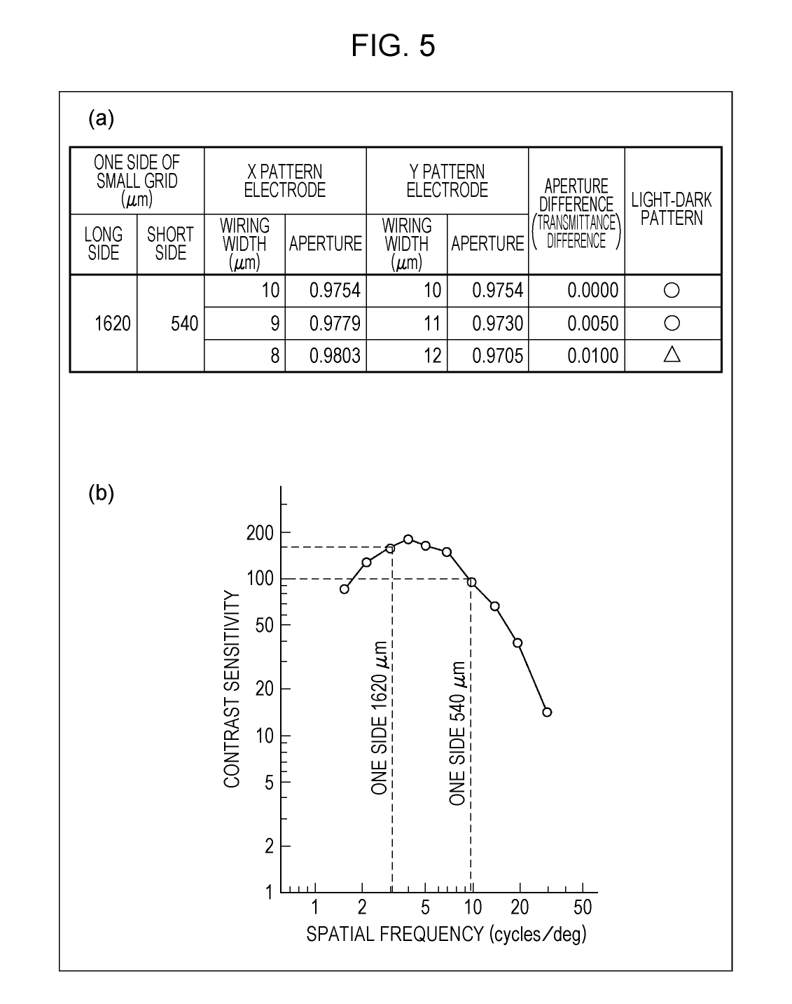

By adopting these design values, as illustrated in FIG. 5(a), even if a variation of ±2 μm occurs in the wiring width in the patterning processes of the X electrode 2 and the Y electrode 4, it is possible to set the difference in the aperture (the transmittance) of the X electrode 2 and the Y electrode 4 to less than or equal to 1%, and it is possible to achieve a degree of the light-dark pattern that poses no practical problems in the touch panel 10.

Note that, it is more preferable that the difference in the aperture (the transmittance) of the X electrode 2 and the Y electrode 4 be set to less than or equal to 0.5%.

As illustrated in FIG. 5(b), 1620 μm, which is the length of the long sides of the rectangular small grids 2u and 4u, is 3.23 (cycle/deg) at a visual distance of 300 mm, and the contrast sensitivity is extremely high; however, 540 μm, which is the length of the short sides of the rectangular small grids 2u and 4u, is 9.70 (cycle/deg) at a visual distance of 300 mm, and the contrast sensitivity drops to approximately less than or equal to 100.

Therefore, the visibility of the mesh-like small grids, that is, the rectangular small grids 2u and 4u is alleviated in comparison to the square case, and it is possible to achieve a degree of mesh-like small grid visibility that poses no practical problems.

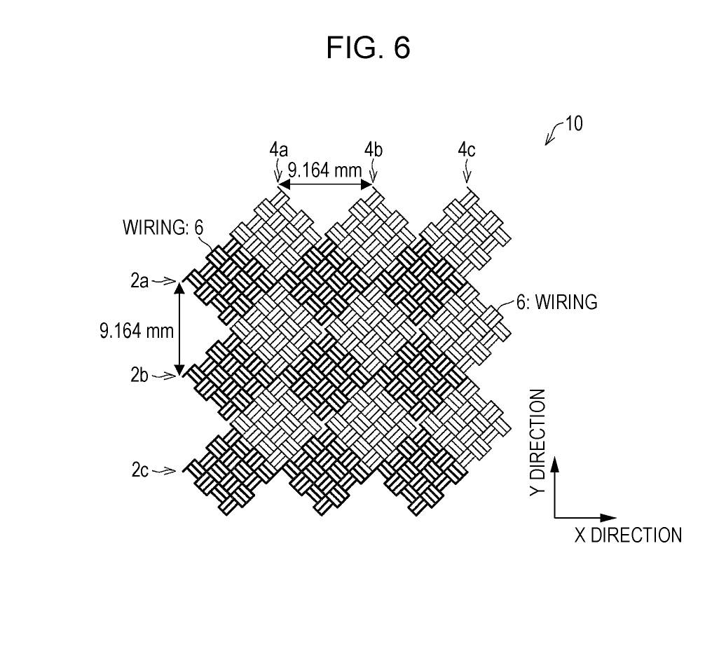

FIG. 6 is a diagram illustrating the pattern of the touch panel electrodes formed of the X electrode 2 and the Y electrode 4 that are manufactured by applying the design values described above.

As illustrated in the drawing, in the touch panel electrodes formed of the X electrode 2 and the Y electrode 4 that are configured by an assemblage of the rectangular small grids 2u and 4u, the electrode pitch of either of the X electrode 2 and the Y electrode 4 is 9.164 mm, and it is possible to cause the touch panel electrodes to operate at favorable performance and precision for a touch panel.

Note that, in the present embodiment, description is given exemplifying touch panel electrodes formed of the X electrode 2 and the Y electrode 4 that are configured by an assemblage of rectangular small grids 2u and 4u, in which the ratio of the long side to the short side is 3:1. However, the configuration is not limited thereto, and even if variation occurs in the wiring width in the patterning processes of the X electrode 2 and the Y electrode 4, it is possible to set the difference in the aperture (the transmittance) of the X electrode 2 and the Y electrode 4 to less than or equal to 1%. In addition, as long as it is possible to set the length of at least one side of the grids described above such that the spatial frequency, which is the number of stripes per 1 degree of visual angle at a visual distance of 300 mm, to greater than or equal to 9 cycle/deg (a contrast sensitivity of approximately less than or equal to 100), the wiring width of the wiring 6 formed of fine metal wires and the shapes of the small grids 2u and 4u are not particularly limited.

Note that, hereinafter, description will be given of the drive principle of the touch panel 10 based on FIG. 1.

As illustrated in the drawing, the substantially square grid unit electrodes 2W in the X electrode 2 and the substantially square grid-shaped unit electrodes 4W in the Y electrode 4 are formed to be adjacent to each other in a touch detection region, a capacitance CF is formed between the adjacent unit electrodes 2W and the unit electrodes 4W; however, the capacitance CF differs between during non-touching and during touching of a detection target such as a finger or a pen. The capacity during touching is greater than the capacity during non-touching (CF_{F}_{_{—}}ᵤₙ_{_{—}}_{ouch}<C_{_{—}}_{touch}). It is possible to detect the touch position by using this principle.

A signal that has a predetermined waveform is sequentially input from terminal portions (not shown) that are electrically connected to each of the electrodes 2a, 2b, 2c . . . in the X electrode 2, and a detection signal is output from the terminal portions (not shown) that are electrically connected to each of the electrodes 4a, 4b, 4c . . . in the Y electrode 4.

### [Second Embodiment]

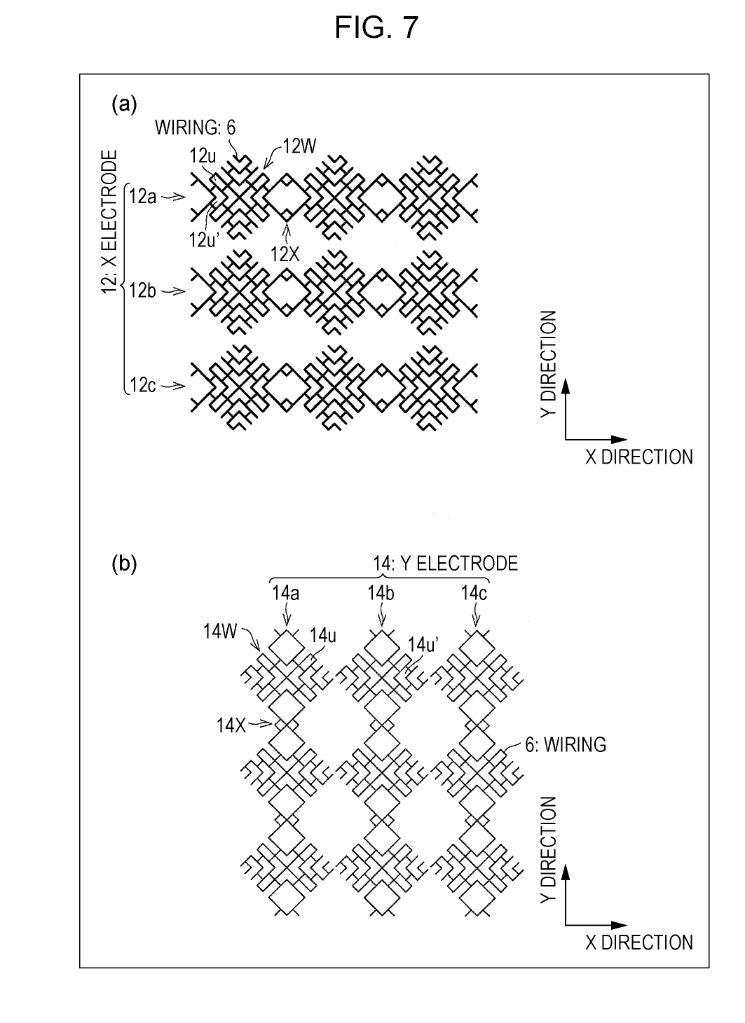

Next, description will be given of the second embodiment of the present invention based on FIGS. 7 to 11. In the touch panel 10 of the first embodiment described above, description is given of touch panel electrodes formed of the X electrode 2 and the Y electrode 4 that are configured by an assemblage of rectangular small grids 2u and 4u, in which the ratio of the long side to the short side is 3:1. However, a touch panel 20 of the present embodiment differs from that of the first embodiment in that an X electrode 12 and a Y electrode 14 are formed of an assemblage of polygonal small grids in which the ratio of the long side to the short side is 2:1, and that connecting portions 12X and 14X are formed such that the connecting portions 12X, which connect substantially square grid-shaped unit electrodes 12W of the X electrode 12 to each other, and the connecting portions 14X, which connect substantially square grid-shaped unit electrodes 14W of the Y electrode 14 to each other, are polygonal small grids when the intersecting locations are seen in plan view. The other configuration of the touch panel 20 is as described in the first embodiment. To facilitate explanation, members that have the same function as the members illustrated in the drawings of the first embodiment described above are referred to by the same reference numerals, and description thereof will be omitted.

FIG. 7 are diagrams illustrating the schematic shapes of the X electrode 12 and the Y electrode 14 provided in the touch panel 20.

FIG. 7(a) illustrates the schematic shape of the X electrode 12, and the X electrode 12 is formed by electrodes 12a, 12b, 12c . . . being arranged in the Y direction in the drawing at a predetermined interval. The electrodes 12a, 12b, 12c . . . are formed by substantially square grid-shaped unit electrodes 12W being electrically connected to each other in the X direction by the connecting portions 12X in the drawing, and the substantially square grid-shaped unit electrodes 12W are formed of a plurality of polygonal small grids, which are formed by the wirings 6 formed of fine metal wires and in which the ratio of the long side to the short side is 2:1.

Meanwhile, FIG. 7(b) illustrates the schematic shape of the Y electrode 14, and the Y electrode 14 is formed by electrodes 14a, 14b, 14c . . . being arranged in the X direction in the drawing at a predetermined interval. The electrodes 14a, 14b, 14c . . . are formed by substantially square grid-shaped unit electrodes 14W being electrically connected to each other in the Y direction by the connecting portions 14X in the drawing, and the substantially square grid-shaped unit electrodes 14W are formed of a plurality of polygonal small grids, which are formed by the wirings 6 formed of fine metal wires and in which the ratio of the long side to the short side is 2:1.

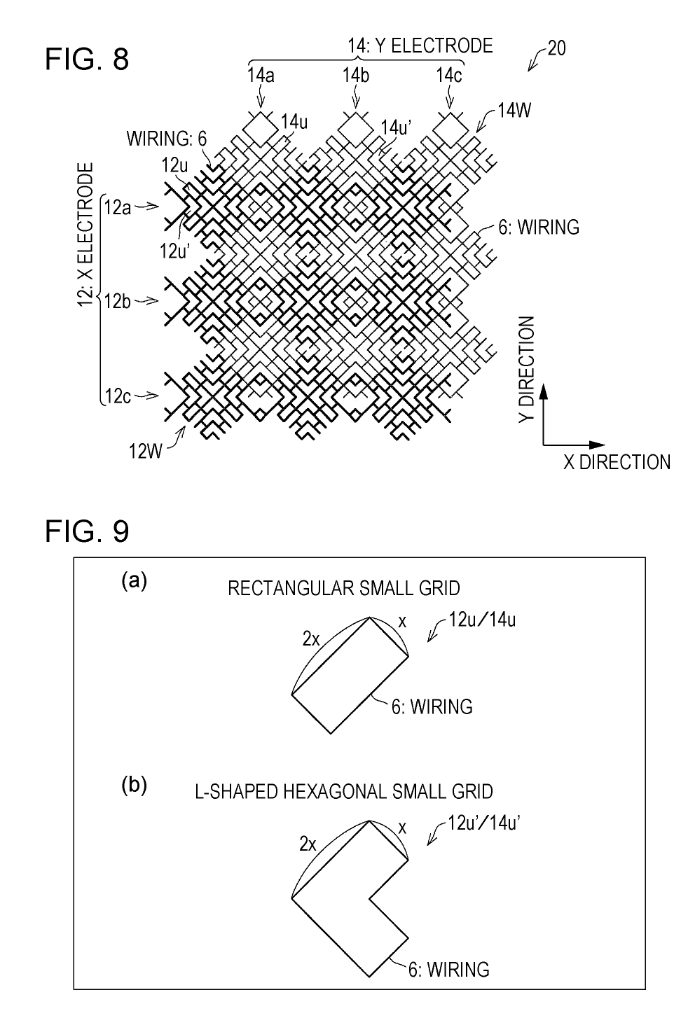

As illustrated in FIGS. 7(a) and 7(b), the connecting portions 12X and 14X are configured by a plurality of square small grids; however, as illustrated in FIG. 8, when the portions at which the connecting portions 12X and the connecting portions 14X intersect are seen in plan view, a polygonal small grid, specifically, an L-shaped hexagonal small grid is apparent.

By configuring the connecting portions 12X and 14X in this manner, there is a plurality of electrical connection paths of the individual electrodes 12a, 12b, 12c, 14a, 14b and 14c, it is possible to reduce the likelihood of faults due to disconnection in comparison to the first embodiment, and it is possible to realize the touch panel 20 with improved productivity and reliability.

FIG. 9 are diagrams illustrating polygonal small grids used in the touch panel 20 of the present embodiment.

FIG. 9(a) illustrates the rectangular small grids 12u and 14u, in which the ratio of the long side to the short side is 2:1, and which are formed by the wiring 6 formed of the fine metal wire, and FIG. 9(b) illustrates L-shaped hexagonal small grids 12u′ and 14u′, in which the ratio of the long side to the short side is 2:1, and which are formed by the wiring 6 formed of the fine metal wire.

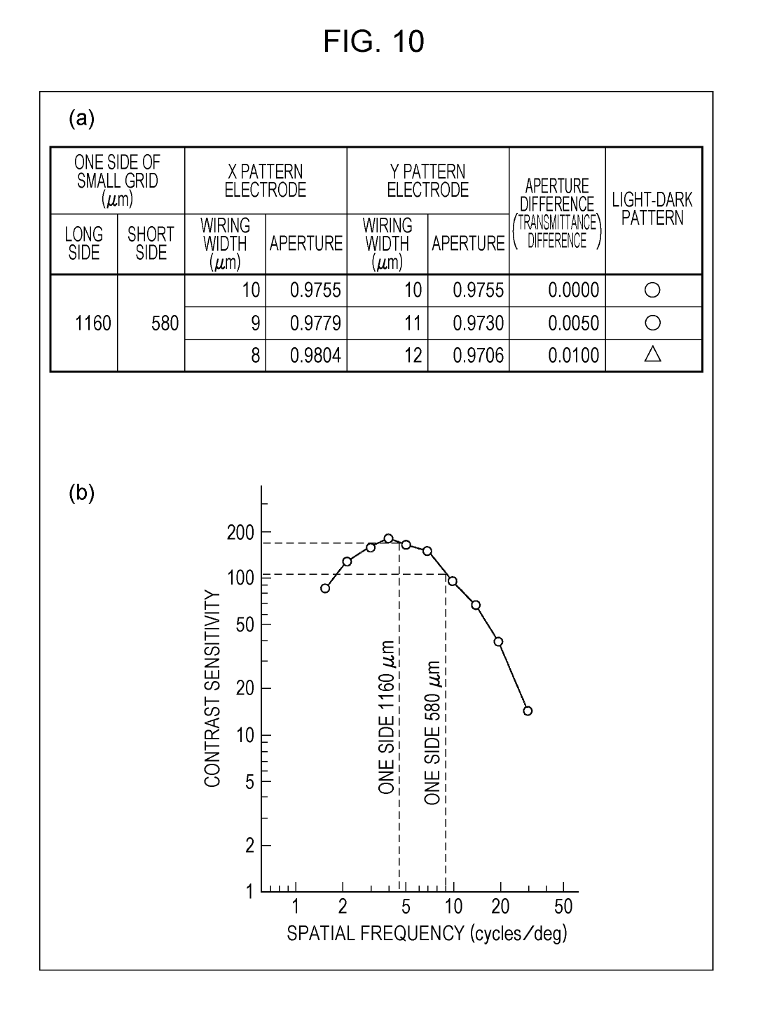

In the present embodiment, in the rectangular small grids 12u and 14u and the L-shaped hexagonal small grids 12u′ and 14u′, by adopting a design in which the wiring width is 10 μm, and for each of the small grids, the long sides are 1160 μm and the short sides are 580 μm, as illustrated in FIG. 10(a), even if a variation of ±2 μm occurs in the wiring width in the patterning processes of the X electrode 12 and the Y electrode 14, it is possible to set the difference in the aperture (the transmittance) of the X electrode 12 and the Y electrode 14 to less than or equal to 1%, and it is possible to achieve a degree of the light-dark pattern that poses no practical problems in the touch panel 20.

As illustrated in FIG. 10(b), 1160 μm, which is the length of the long sides of the L-shaped hexagonal small grids 12u′ and 14u′ and the rectangular small grids 12u and 14u, is 4.51 (cycle/deg) at a visual distance of 300 mm, and the contrast sensitivity is extremely high; however, 580 μm, which is the length of the short sides of the rectangular small grids 12u and 14u and the L-shaped hexagonal small grids 12u′ and 14u′, is 9.03 (cycle/deg) at a visual distance of 300 mm, and the contrast sensitivity drops to approximately less than or equal to 100.

As illustrated in FIG. 8, since the touch panel electrodes provided in the touch panel 20 are disposed such that the ultra-fine wiring of cycle 1160 μm and cycle 580 μm are mixed together, the touch panel electrodes are not easily recognizable as a cyclic pattern.

Therefore, the visibility of the rectangular small grids 12u and 14u and the L-shaped hexagonal small grids 12u′ and 14u′ is alleviated in comparison to the first embodiment described above, and it is possible to achieve a degree of visibility that is favorable in practice.

When the portions at which the connecting portions 12X and the connecting portions 14X intersect are viewed in plan view, the polygonal small grid, specifically, the L-shaped hexagonal small grid is apparent, and this portion has the same effect as that of the L-shaped hexagonal small grids 12u′ and 14u.

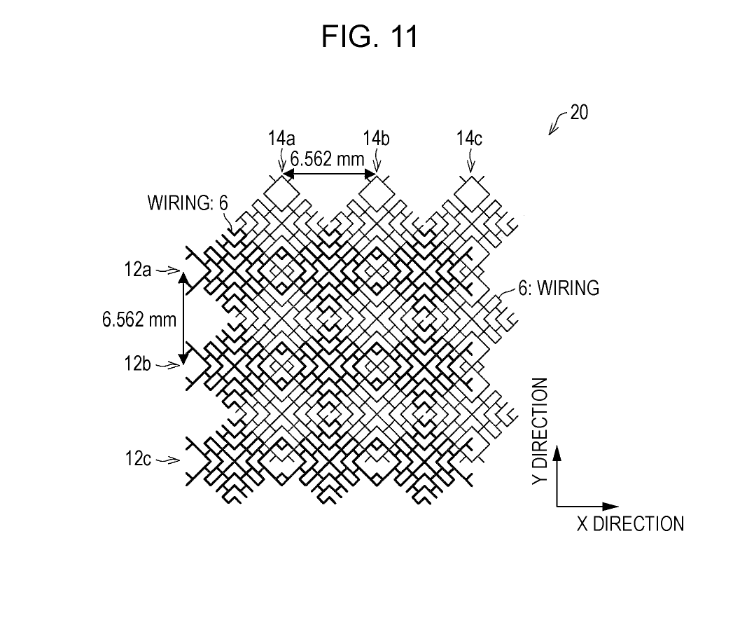

FIG. 11 is a diagram illustrating the pattern of the touch panel electrodes formed of the X electrode 12 and the Y electrode 14 that are manufactured by applying the design values described above.

As illustrated in the drawing, in the touch panel electrodes formed of the X electrode 12 and the Y electrode 14 that are configured by an assemblage of the rectangular small grids 12u and 14u and the L-shaped hexagonal small grids 12u′ and 14u′, the electrode pitch of either of the X electrode 12 and the Y electrode 14 is 6.562 mm, and it is possible to cause the touch panel electrodes to operate at favorable performance and precision for a touch panel.

### [Third Embodiment]

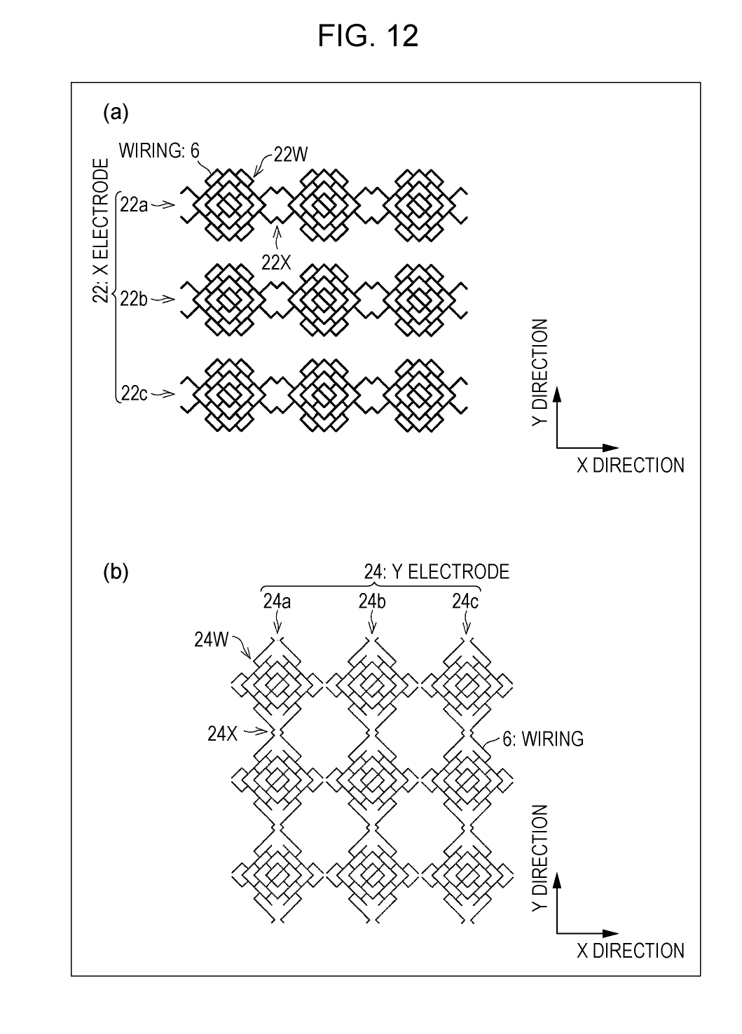

Next, description will be given of the third embodiment of the present invention based on FIGS. 12 to 14. This is the same as the second embodiment described above in that an X electrode 22 and a Y electrode 24 are formed by an assemblage of polygonal small grids in which the ratio of the long side to the short side is 2:1; however, connecting portions 22X, which connect substantially square grid-shaped unit electrodes 22W of the X electrode 22 to each other, and connecting portions 24X, which connect substantially square grid-shaped unit electrodes 24W of the Y electrode 24 to each other, are have different shapes from those in the second embodiment described above, and the other configuration is as described in the second embodiment. To facilitate explanation, members that have the same function as the members illustrated in the drawings of the second embodiment described above are referred to by the same reference numerals, and description thereof will be omitted.

FIG. 12 are diagrams illustrating the schematic shapes of the X electrode 22 and the Y electrode 24 provided in a touch panel 30.

FIG. 12(a) illustrates the schematic shape of the X electrode 22, and the X electrode 22 is formed by electrodes 22a, 22b, 22c . . . being arranged in the Y direction in the drawing at a predetermined interval. The electrodes 22a, 22b, 22c . . . are formed by substantially square grid-shaped unit electrodes 22W being electrically connected to each other in the X direction by the connecting portions 22X in the drawing, and the substantially square grid-shaped unit electrodes 22W are formed of a plurality of polygonal small grids, which are formed by the wirings 6 formed of fine metal wires and in which the ratio of the long side to the short side is 2:1.

Meanwhile, FIG. 12(b) illustrates the schematic shape of the Y electrode 24, and the Y electrode 24 is formed by electrodes 24a, 24b, 24c . . . being arranged in the X direction in the drawing at a predetermined interval. The electrodes 24a, 24b, 24c . . . are formed by substantially square grid-shaped unit electrodes 24W being electrically connected to each other in the Y direction by the connecting portions 24X in the drawing, and the substantially square grid-shaped unit electrodes 24W are formed of a plurality of polygonal small grids, which are formed by the wirings 6 formed of fine metal wires and in which the ratio of the long side to the short side is 2:1.

The connecting portions 22X and 24X illustrated in FIGS. 12(a) and 12(b), as illustrated in FIG. 13, intersect each other in plan view, and in the intersecting portions, a substantially L-shaped hexagon is apparent, and, there is a plurality of electrical connection paths of the individual electrodes 22a, 22b, 22c, 24a, 24b, and 24c.

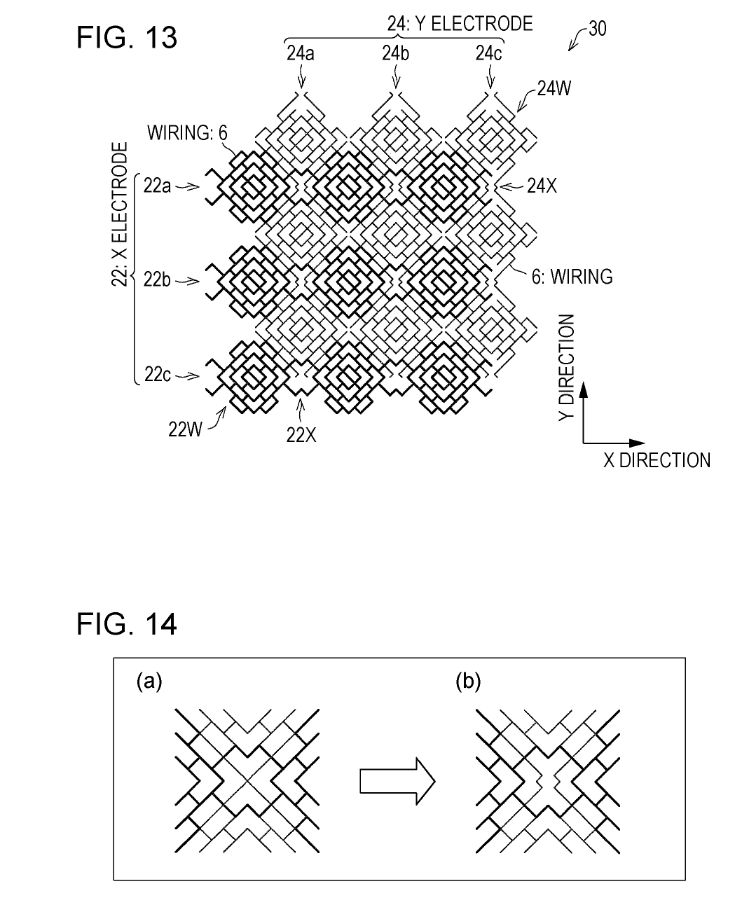

FIG. 14(a) illustrates a case in which, in an intersecting portion of a connecting portion, an L-shaped hexagonal shape is apparent and the electrical connection between the unit electrodes of the Y electrode is a single path, and 14(b) is the configuration used in the present embodiment of the invention, and illustrates a case in which, in the intersecting portion of the connecting portion, a substantially L-shaped hexagonal shape is apparent and the electrical connection between the unit electrodes of the Y electrode is two paths.

In the touch panel 30 in the present embodiment, since this configuration is used, it is possible to reduce the likelihood of faults due to disconnection, and it is possible to improve the productivity and reliability.

Note that, in relation to the problem of the visibility of the light-dark pattern and the polygonal small grid in the touch panel 30, the present embodiment has the same effects as those of the second embodiment described above.

### [Fourth Embodiment]

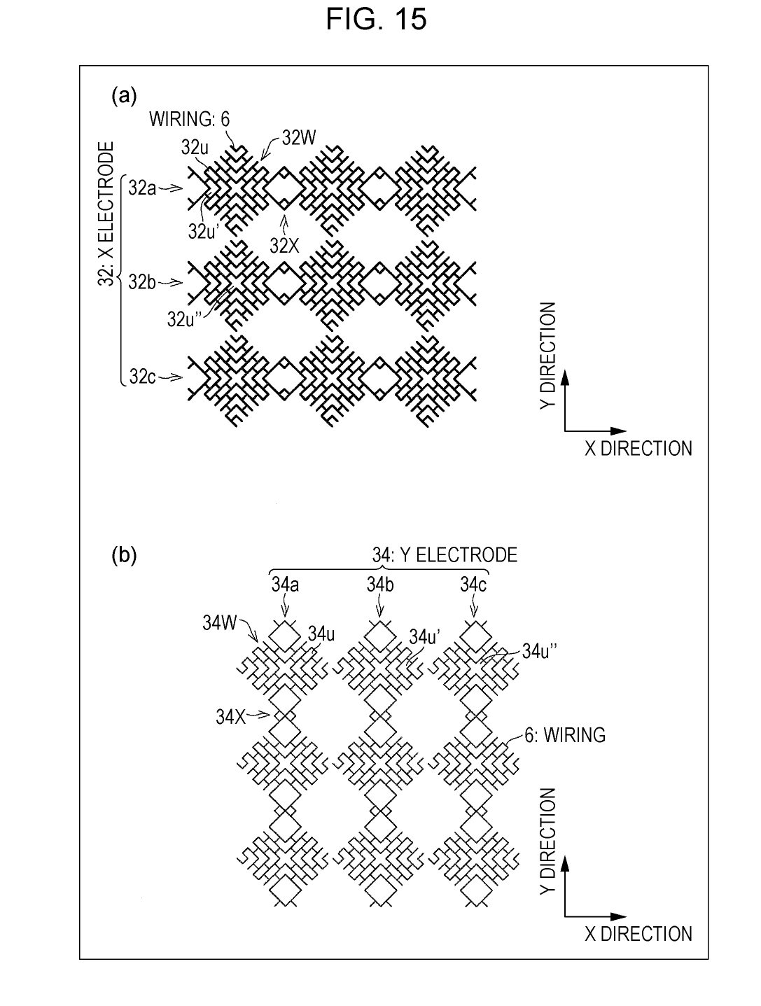

Next, description will be given of the fourth embodiment of the present invention based on FIGS. 15 to 19.

This is the same as the second and third embodiments described above in that an X electrode 32 and a Y electrode 34 are formed by an assemblage of polygonal small grids in which the ratio of the long side to the short side is 2:1; however, the present embodiment differs from the second and third embodiments in that an x-shaped dodecagonal small grid formed of only sides having the same length as the short side of the polygonal small grid in which the ratio of the long side to the short side is 2:1 is further included, and the other configuration is as described in the second and third embodiments. To facilitate explanation, members that have the same function as the members illustrated in the drawings of the second and third embodiments described above are referred to by the same reference numerals, and description thereof will be omitted.

FIG. 15 are diagrams illustrating the schematic shapes of the X electrode 32 and the Y electrode 34 provided in a touch panel 40.

FIG. 15(a) illustrates the schematic shape of the X electrode 32, and the X electrode 32 is formed by electrodes 32a, 32b, 32c . . . being arranged in the Y direction in the drawing at a predetermined interval. The electrodes 32a, 32b, 32c . . . are formed by substantially square grid-shaped unit electrodes 32W being electrically connected to each other in the X direction by connecting portions 32X in the drawing, and the substantially square grid-shaped unit electrodes 32W are formed of a plurality of polygonal small grids 32u and 32u′, which are formed by the wirings 6 formed of fine metal wires and in which the ratio of the long side to the short side is 2:1, and x-shaped dodecagonal small grids 32u″ formed of only sides having the same length as the short sides of the polygonal small grids 32u and 32u′.

FIG. 15(b) illustrates the schematic shape of the Y electrode 34, and the Y electrode 34 is formed by electrodes 34a, 34b, 34c . . . being arranged in the X direction in the drawing at a predetermined interval. The electrodes 34a, 34b, 34c . . . are formed by substantially square grid-shaped unit electrodes 34W being electrically connected to each other in the Y direction by connecting portions 34X in the drawing, and the substantially square grid-shaped unit electrodes 34W are formed of a plurality of polygonal small grids 34u and 34u′, which are formed by the wirings 6 formed of fine metal wires and in which the ratio of the long side to the short side is 2:1, and x-shaped dodecagonal small grids 34u″ formed of only sides having the same length as the short sides of the polygonal small grids 34u and 34u′.

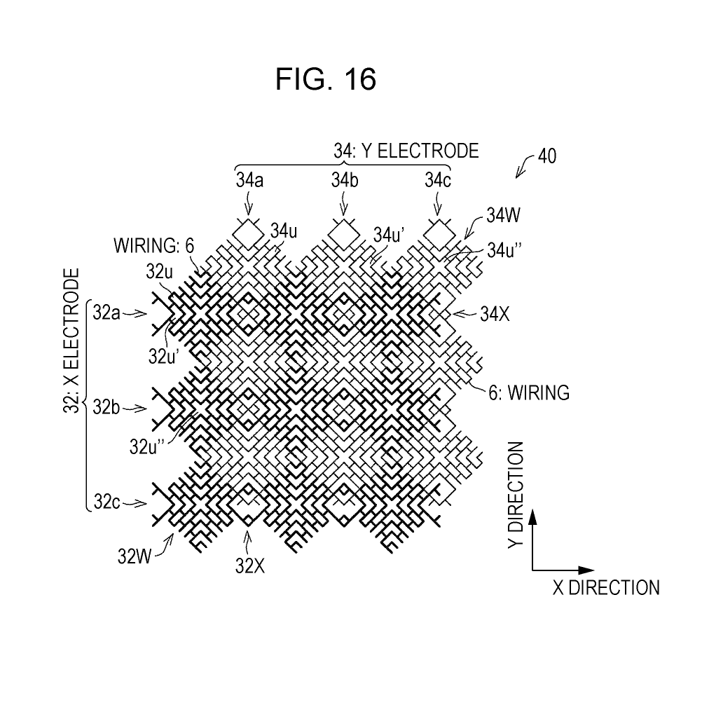

The connecting portions 32X and 34X illustrated in FIGS. 15(a) and 15(b), as illustrated in FIG. 16, intersect each other in plan view, and in the intersecting portions, a substantially L-shaped hexagon is apparent, and, there is a plurality of electrical connection paths of the individual electrodes 32a, 32b, 32c, 34a, 34b, and 34c.

In the touch panel 40 in the present embodiment, since this configuration is used, it is possible to reduce the likelihood of faults due to disconnection, and it is possible to improve the productivity and reliability.

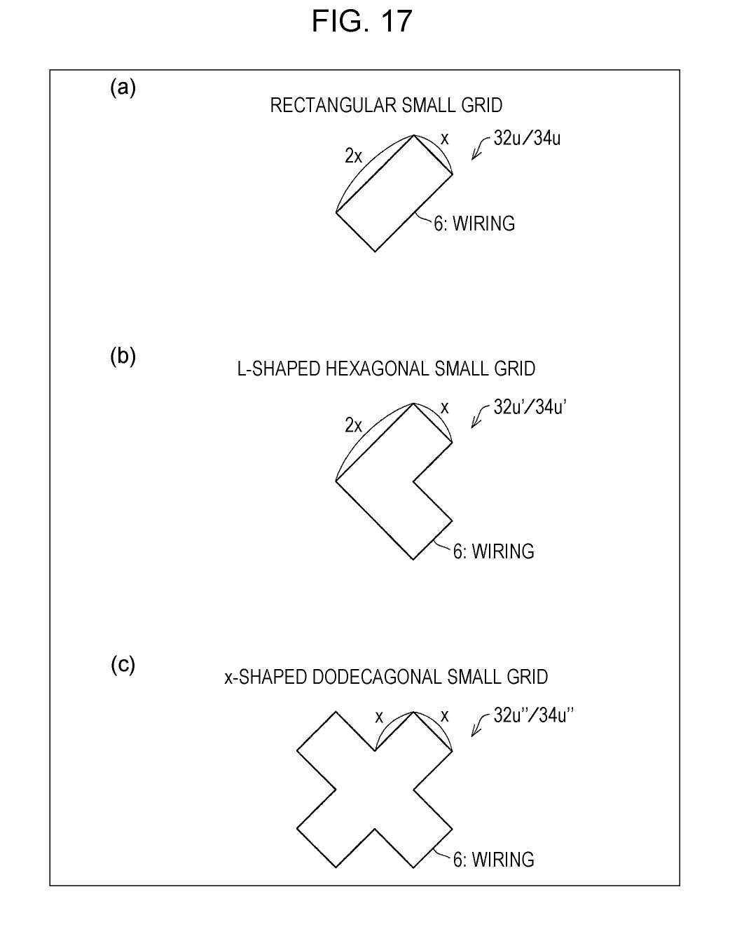

FIG. 17 are diagrams illustrating polygonal small grids used in the touch panel 40 of the present embodiment.

FIG. 17(a) illustrates the rectangular small grids 32u and 34u, in which the ratio of the long side to the short side is 2:1, and which are formed by the wiring 6 formed of the fine metal wire, FIG. 17(b) illustrates the L-shaped hexagonal small grids 32u′ and 34u′, in which the ratio of the long side to the short side is 2:1, and which are formed by the wiring 6 formed of the fine metal wire, and FIG. 17(c) illustrates the x-shaped dodecagonal small grid 32u″ and 34u″, which are formed of only sides having the same length as the short sides of the polygonal small grids in which ratio of the long to the short side is 2:1, and which are formed by the wiring 6 formed of the fine metal wire.

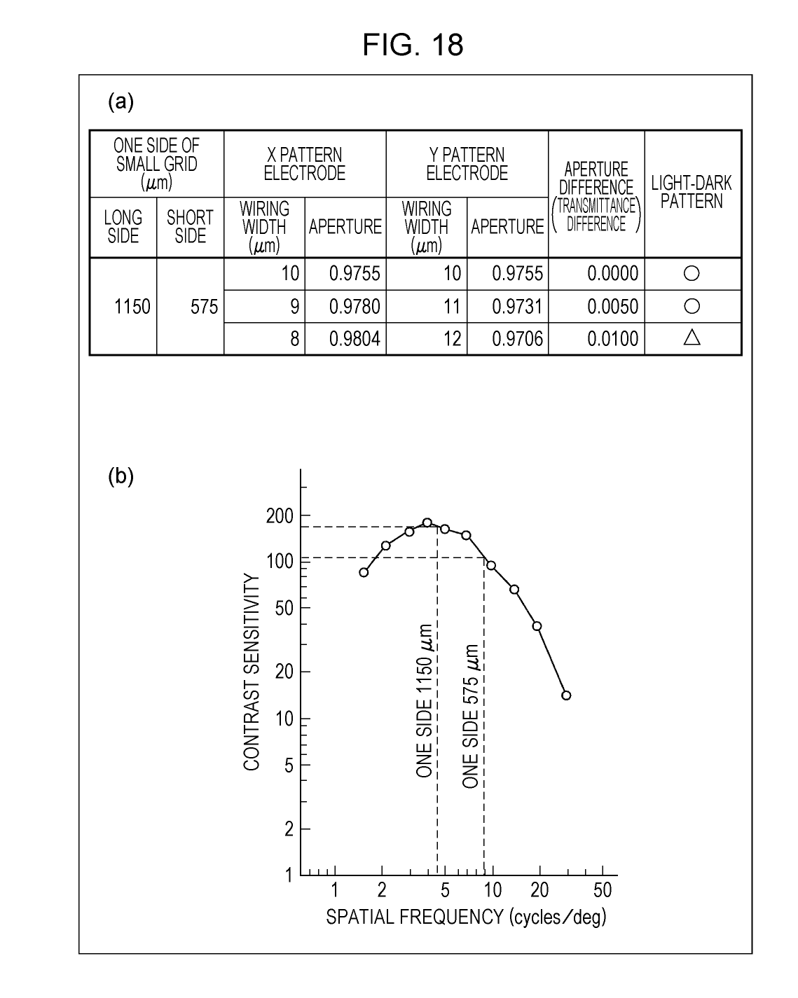

In the present embodiment, in the rectangular small grids 32u and 34u and the L-shaped hexagonal small grids 32u′ and 34u′, by adopting a design in which the wiring width is 10 μm, and for each of the small grids, the long sides are 1150 μm and the short sides are 575 μm, and in the x-shaped dodecagonal small grids 32u″ and 34u″, the wiring width is 10 μm and the length of one side is 575 μm, as illustrated in FIG. 18(a), even if a variation of ±2 μm occurs in the wiring width in the patterning processes of the X electrode 32 and the Y electrode 34, it is possible to set the difference in the aperture (the transmittance) of the X electrode 32 and the Y electrode 34 to less than or equal to 1%, and it is possible to achieve a degree of the light-dark pattern that poses no practical problems in the touch panel 40.

As illustrated in FIG. 18(b), 1150 μm, which is the length of one side of the rectangular small grids, is 4.55 (cycle/deg) at a visual distance of 300 mm, and the contrast sensitivity is extremely high; however, 575 μm, which is the length of the other side of the rectangular small grid, is 9.11 (cycle/deg) at a visual distance of 300 mm, and the contrast sensitivity drops to approximately less than or equal to 100.

As illustrated in FIG. 16, since the touch panel electrodes provided in the touch panel 40 are disposed such that the ultra-fine wiring of cycle 1150 μm and cycle 575 μm are mixed together, the touch panel electrodes are not easily recognizable as a cyclic pattern.

Therefore, the visibility of the rectangular small grids 32u and 34u, the L-shaped hexagonal small grids 32u′ and 34u′, and the x-shaped dodecagonal small grid 32u″ and 34u″ is further alleviated, and it is possible to achieve a degree of visibility that is favorable in practice.

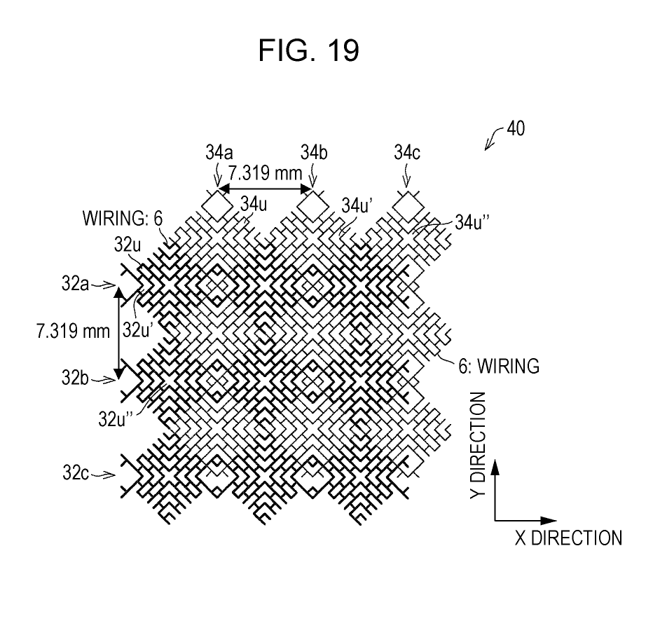

FIG. 19 is a diagram illustrating the pattern of the touch panel electrodes formed of the X electrode 32 and the Y electrode 34 that are manufactured by applying the design values described above.

As illustrated in the drawing, in the touch panel electrodes formed of the X electrode 32 and the Y electrode 34 that are configured by an assemblage of the rectangular small grids 32u and 34u, the L-shaped hexagonal small grids 32u′ and 34u′, and the x-shaped dodecagonal small grids 32u″ and 34u″, the electrode pitch of either of the X electrode 32 and the Y electrode 34 is 7.319 mm, and it is possible to cause the touch panel electrodes to operate at favorable performance and precision for a touch panel.

### [Fifth Embodiment]

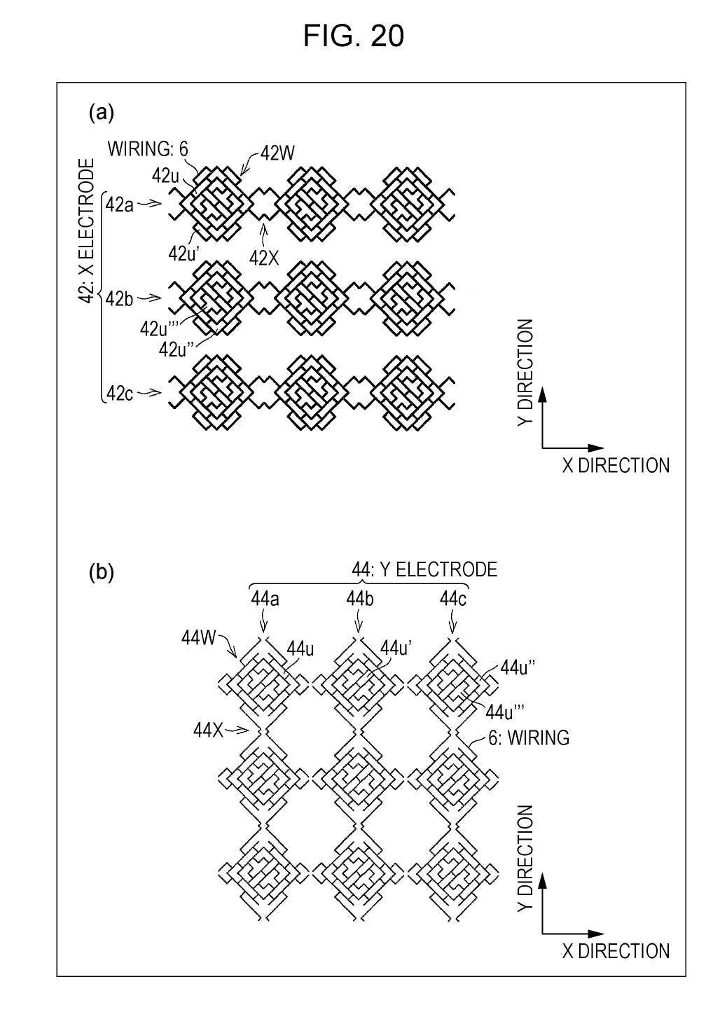

Next, description will be given of the fifth embodiment of the present invention based on FIGS. 20 to 24.

The fifth embodiment differs from the first to fourth embodiments in that an assemblage of four types of polygonal small grid in which the ratios of the long side to the short side differ is used in the formation of an X electrode 42 and a Y electrode 44, and the other configuration is as described in the first to fourth embodiments. To facilitate explanation, members that have the same function as the members illustrated in the drawings of the first to fourth embodiments described above are referred to by the same reference numerals, and description thereof will be omitted.

FIG. 20 are diagrams illustrating the schematic shapes of the X electrode 42 and the Y electrode 44 provided in a touch panel 50.

FIG. 20(a) illustrates the schematic shape of the X electrode 42, and the X electrode 42 is formed by electrodes 42a, 42b, 42c . . . being arranged in the Y direction in the drawing at a predetermined interval. The electrodes 42a, 42b, 42c . . . are formed by substantially square grid-shaped unit electrodes 42W being electrically connected to each other in the X direction by the connecting portions 42X in the drawing, and the substantially square grid-shaped unit electrodes 42W are formed of four types of polygonal small grids 42u, 42u′, 42u″, and 42u′″, which are formed by the wirings 6 formed of fine metal wires and in which the ratios of the long side to the short side differ.

Meanwhile, FIG. 20(b) illustrates the schematic shape of the Y electrode 44, and the Y electrode 44 is formed by electrodes 44a, 44b, 44c . . . being arranged in the X direction in the drawing at a predetermined interval. The electrodes 44a, 44b, 44c . . . are formed by substantially square grid-shaped unit electrodes 44W being electrically connected to each other in the Y direction by the connecting portions 44X in the drawing, and the substantially square grid-shaped unit electrodes 44W are formed of four types of polygonal small grids 44u, 44u′, 44u″, and 44u′″, which are formed by the wirings 6 formed of fine metal wires and in which the ratios of the long side to the short side differ.

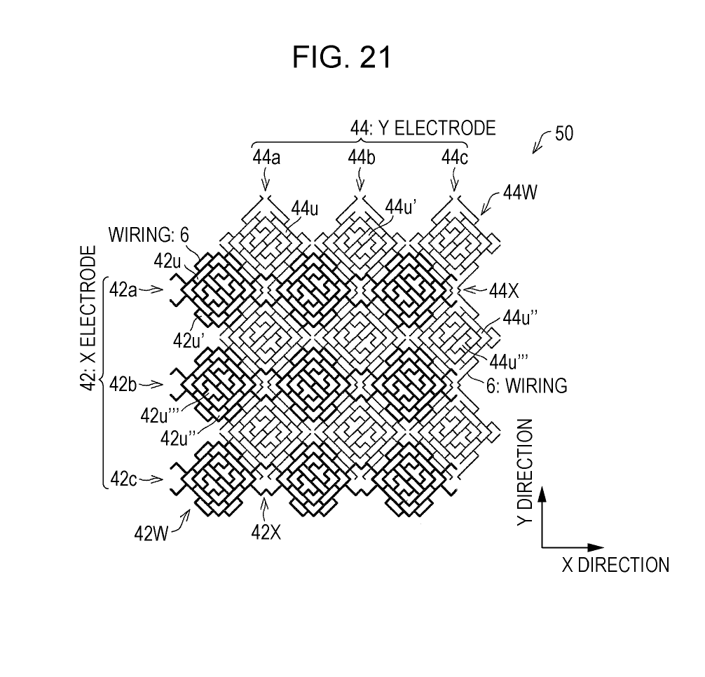

The connecting portions 42X and 44X illustrated in FIGS. 20(a) and 20(b), as illustrated in FIG. 21, intersect each other in plan view, and in the intersecting portions, a substantially L-shaped hexagon is apparent, and, there is a plurality of electrical connection paths of the individual electrodes 42a, 42b, 42c, 44a, 44b, and 44c.

Therefore, in the touch panel 50 in the present embodiment, since this configuration is used, it is possible to reduce the likelihood of faults due to disconnection, and it is possible to improve the productivity and reliability.

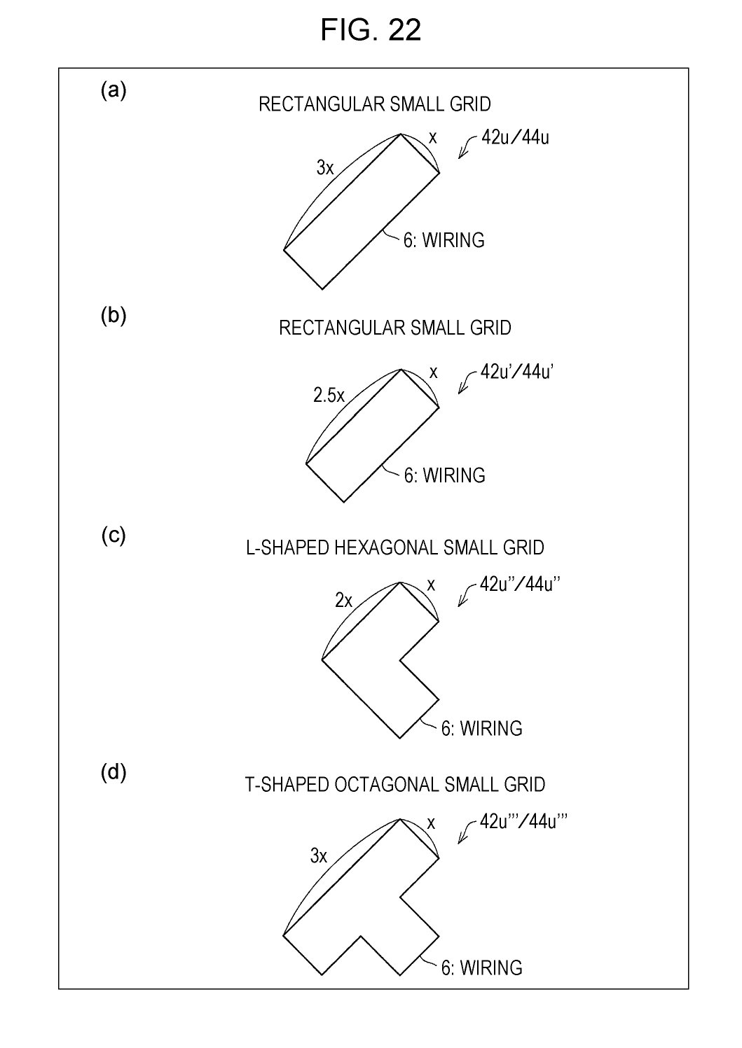

FIG. 22 are diagrams illustrating polygonal small grids used in the touch panel 50 of the present embodiment.

FIG. 22(a) illustrates the rectangular small grids 42u and 44u, in which the ratio of the long side to the short side is 3:1, and which are formed by the wiring 6 formed of the fine metal wire, FIG. 22(b) illustrates the rectangular small grids 42u′ and 44u′, in which the ratio of the long side to the short side is 2.5:1, and which are formed by the wiring 6 formed of the fine metal wire, FIG. 22(c) illustrates the L-shaped hexagonal small grids 42u″ and 44u″, in which the ratio of the long side to the short side is 2:1, and which are formed by the wiring 6 formed of the fine metal wire, and FIG. 22(d) illustrates the T-shaped octagonal small grid 42u′″ and 44u′″, in which the ratio of the long side to the short side is 3:1, and which are formed by the wiring 6 formed of the fine metal wire.

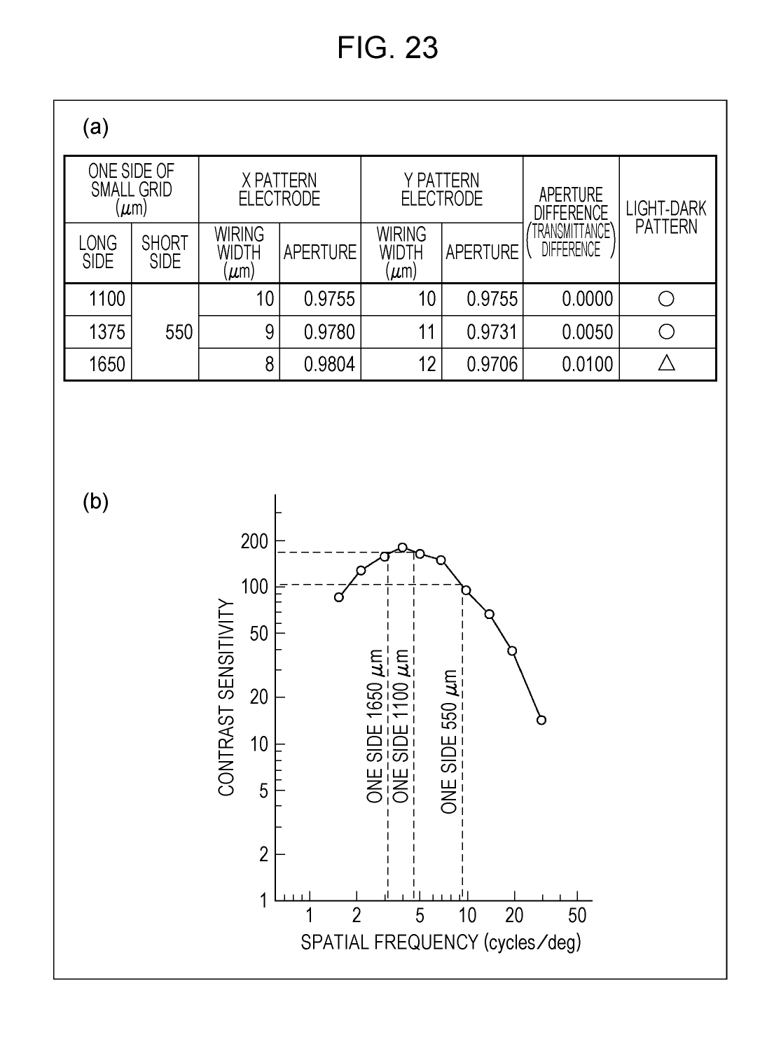

In the present embodiment, in the rectangular small grids 42u, 44u, 42u′, and 44u′, the L-shaped hexagonal small grids 42u″ and 44u″, and the T-shaped octagonal small grids 42u′″ and 44u′″, by adopting a design in which the wiring width is 10 μm, and for each of the small grids, the short sides are set to 550 μm and the long sides are set to 1100 μm, 1375 μm, or 1650 μm according to the corresponding ratio, as illustrated in FIG. 23(a), even if a variation of ±2 μm occurs in the wiring width in the patterning processes of the X electrode 42 and the Y electrode 44, it is possible to set the difference in the aperture (the transmittance) of the X electrode 42 and the Y electrode 44 to less than or equal to 1%, and it is possible to achieve a degree of the light-dark pattern that poses no practical problems in the touch panel 50.

As illustrated in FIG. 23(b), 1100 μm, 1375 μm, and 1650 μm, which are the lengths of one side of the polygonal small grids, are 4.76, 3.81, and 3.17 (cycle/deg) at a visual distance of 300 mm, and the contrast sensitivity is extremely high; however, 550 μm, which is the length of the other side of the polygonal small grids, is 9.52 (cycle/deg) at a visual distance of 300 mm, and the contrast sensitivity drops to approximately less than or equal to 100.

As illustrated in FIG. 21, since the touch panel electrodes provided in the touch panel 50 are disposed such that the ultra-fine wiring of cycle 1100 μm, cycle 1375 μm, cycle 1650 μm, and cycle 550 μm are mixed together, the touch panel electrodes are not easily recognizable as a cyclic pattern.

Therefore, the visibility of the rectangular small grids 42u, 44u, 42u′ and 44u′, the L-shaped hexagonal small grids 42u″ and 44u″, and the T-shaped octagonal small grid 42u′″ and 44u′″ is further alleviated, and it is possible to achieve a degree of visibility that is favorable in practice.

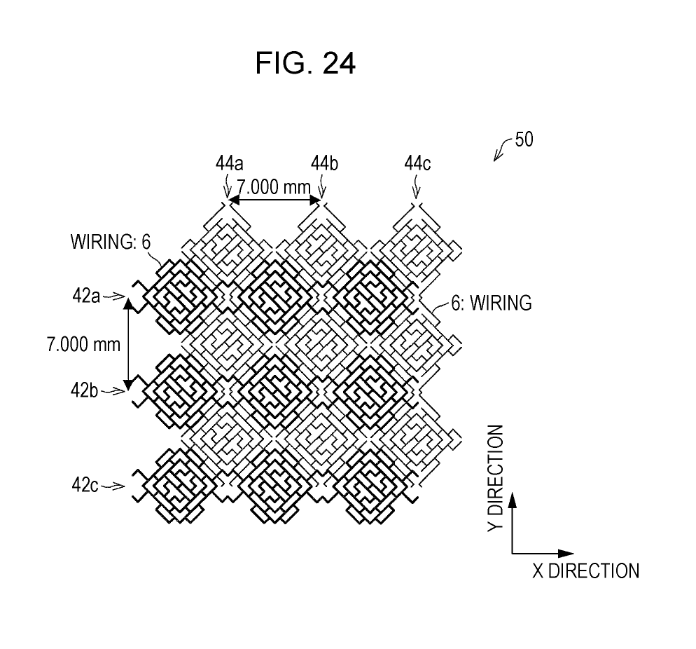

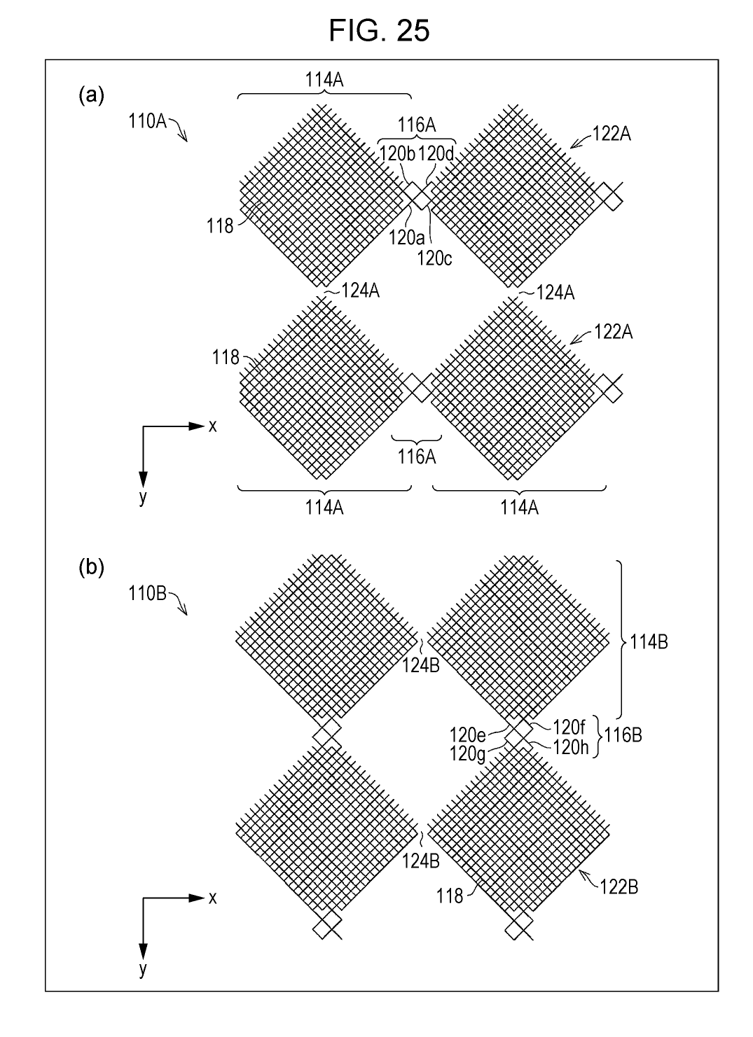

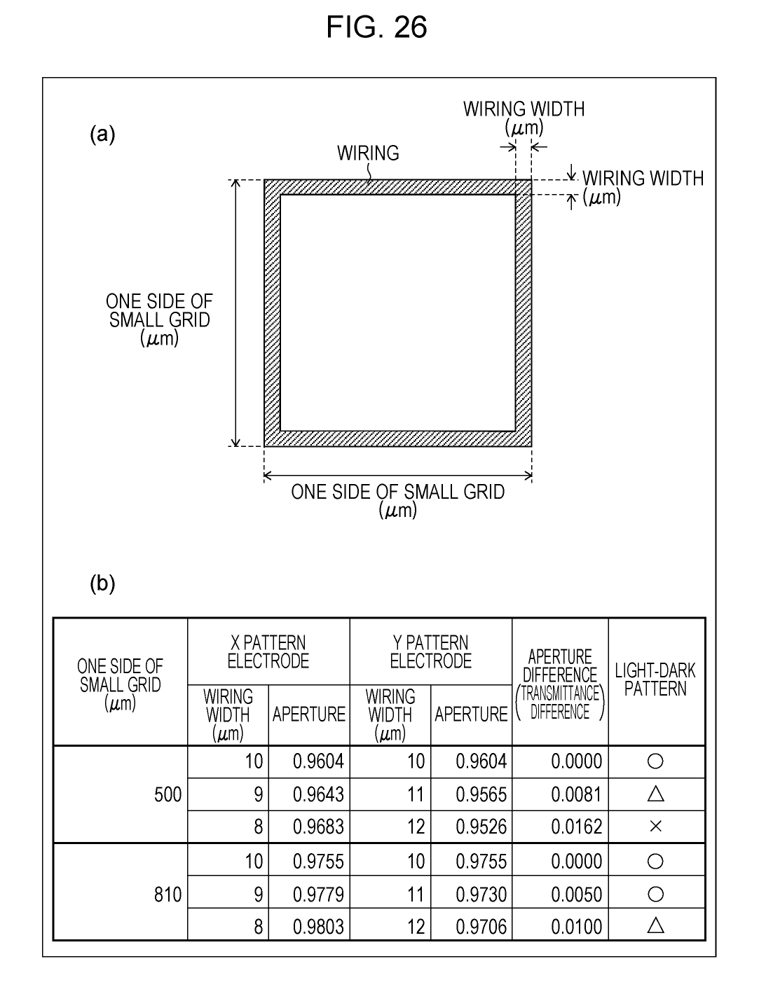

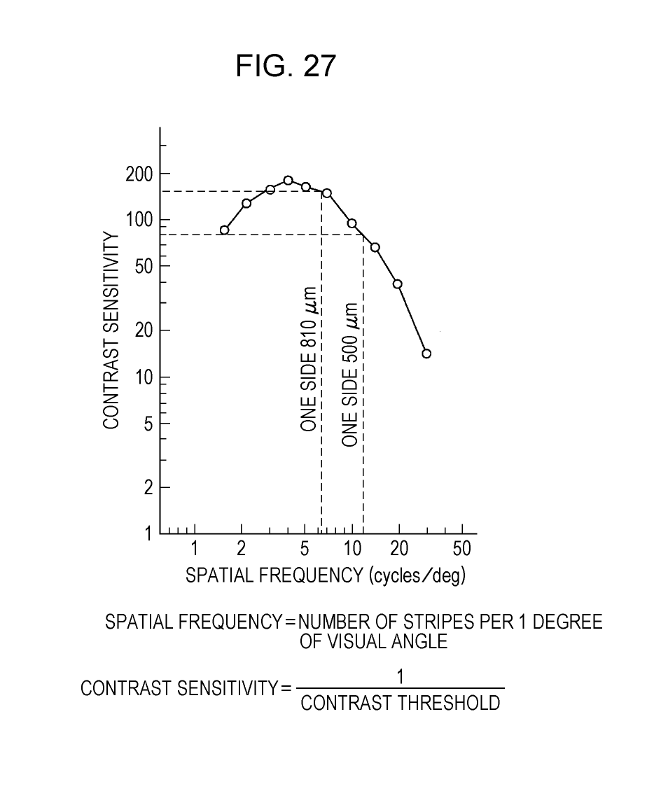

FIG. 24 is a diagram illustrating the pattern of the touch panel electrodes formed of the X electrode 42 and the Y electrode 44 that are manufactured by applying the design values described above.

As illustrated in the drawing, in the touch panel electrodes formed of the X electrode 42 and the Y electrode 44 that are configured by an assemblage of the rectangular small grids 42u, 44u, 42u′, and 44u′, the L-shaped hexagonal small grids 42u″ and 44u″, and the T-shaped octagonal small grids 42u′″ and 44u′″, the electrode pitch of either of the X electrode 42 and the Y electrode 44 is 7 mm, and it is possible to cause the touch panel electrodes to operate at favorable performance and precision for a touch panel.

In the touch panel of the present invention, it is preferable that the plurality of grids be formed in a polygonal shape other than a regular polygonal shape.

In the touch panel of the present invention, it is preferable that the plurality of grids include a plurality of grids of different shapes.

In the touch panel of the present invention, it is preferable that the plurality of grids be formed of grids of the same shape.

In the touch panel according of the present invention, it is preferable that a first connecting portion which connects the plurality of first unit electrodes to each other be provided in the first electrode row, a second connecting portion which connects the plurality of second unit electrodes to each other be provided in the second electrode row, the first connecting portion and the second connecting portion be formed to interpose an insulating layer, and the shape of the grid be formed at a portion at which the first connecting portion and the second connecting portion overlap in plan view.

According to this configuration, since the shape of the grid is also formed at the portion at which the first connecting portion and the second connecting portion overlap in plan view, the first connecting portion and the second connecting portion can realize a touch panel capable of suppressing the visibility of the light-dark pattern and the mesh-like small grid.

In the touch panel of the present invention, the shape of the grid may be a rectangle.

In the touch panel of the present invention, the shape of the grid may be an L-shaped hexagon.

In the touch panel of the present invention, the shape of the grid may be an x-shaped dodecagon.

In the touch panel of the present invention, the shape of the grid may be a T-shaped octagon.

In the touch panel of the present invention, it is preferable that the transmittance between the plurality of grids be less than or equal to 0.5%.

According to this configuration, it is possible to realize a touch panel capable of further suppressing the visibility of the light-dark pattern.

In the touch panel of the present invention, it is preferable that a wiring portion formed at the first cycle interval be formed such that contrast sensitivity is lower than a wiring portion formed at the second cycle interval.

In the touch panel of the present invention, it is preferable that a length of a wiring portion formed at the first cycle interval be formed such that a spatial frequency, which is a number of stripes per 1 degree of visual angle at a visual distance of 300 mm, is greater than or equal to 9 cycle/deg (the contrast sensitivity is less than or equal to 100).

According to this configuration, since the wiring portion formed at the first cycle interval is formed such that the contrast sensitivity decreases, it is possible to realize a touch panel capable of further suppressing the visibility of the small grid.

The present invention is not limited by the embodiments described above, various modifications are possible within the scope indicated in the claims, and embodiments obtained by combining, as appropriate, the technical means disclosed in each of the different embodiments are also included in the technical scope of the present invention.

### INDUSTRIAL APPLICABILITY

The present invention can be used favorably in a touch panel and a display device provided with a touch panel.

### REFERENCE SIGNS LIST

2 X ELECTRODE (FIRST ELECTRODE)

2a, 2b, 2c ELECTRODES (EXAMPLES OF FIRST ELECTRODE)

2u, 4u RECTANGULAR SMALL GRIDS (GRIDS)

2w, 4w UNIT ELECTRODES

6 Y ELECTRODE (SECOND ELECTRODE)

4a, 4b, 4c ELECTRODES (EXAMPLES OF SECOND ELECTRODE)

6 WIRING FORMED OF FINE METAL WIRE

10 TOUCH PANEL

12 X ELECTRODE (FIRST ELECTRODE)

12a, 12b, 12c ELECTRODES (EXAMPLES OF FIRST ELECTRODE)

12w, 14w UNIT ELECTRODES

12X, 14X CONNECTING PORTIONS

12u, 14u RECTANGULAR SMALL GRIDS (GRIDS)

12u′, 14u′ L-SHAPED HEXAGONAL SMALL GRIDS (GRIDS)

14 Y ELECTRODE (SECOND ELECTRODE)

14a, 14b, 14c ELECTRODES (EXAMPLES OF SECOND ELECTRODE)

20 TOUCH PANEL

22 X ELECTRODE (FIRST ELECTRODE)

22a, 22b, 22c ELECTRODES (EXAMPLES OF FIRST ELECTRODE)

22w, 24w UNIT ELECTRODES

22X, 24X CONNECTING PORTIONS

24 Y ELECTRODE (SECOND ELECTRODE)

24a, 24b, 24c ELECTRODES (EXAMPLES OF SECOND ELECTRODE)

30 touch panel

32 X ELECTRODE (FIRST ELECTRODE)

32a, 32b, 32c ELECTRODES (EXAMPLES OF FIRST ELECTRODE)

32w, 34w UNIT ELECTRODES

32X, 34X CONNECTING PORTIONS

32u, 34u RECTANGULAR SMALL GRIDS (GRIDS)

32u′, 34u′ L-SHAPED HEXAGONAL SMALL GRIDS (GRIDS)

32u″, 34u″ x-SHAPED DODECAGONAL SMALL GRIDS (GRIDS)

34 Y ELECTRODE (SECOND ELECTRODE)

34a, 34b, 34c ELECTRODES (EXAMPLES OF SECOND ELECTRODE)

40 TOUCH PANEL

42 X ELECTRODE (FIRST ELECTRODE)

42a, 42b, 42c ELECTRODES (EXAMPLES OF FIRST ELECTRODE)

42w, 44w UNIT ELECTRODES

42X, 44X CONNECTING PORTIONS

42u, 44u RECTANGULAR SMALL GRIDS (GRIDS)

42u′, 44u′ RECTANGULAR SMALL GRIDS (GRIDS)

42u″, 44u″ L-SHAPED HEXAGONAL SMALL GRIDS (GRIDS)

42u′″, 44u′″ T-SHAPED OCTAGONAL SMALL GRIDS (GRIDS)

44 Y ELECTRODE (SECOND ELECTRODE)

44a, 44b, 44c ELECTRODES (EXAMPLES OF SECOND ELECTRODE)

50 TOUCH PANEL

X DIRECTION FIRST DIRECTION

Y DIRECTION SECOND DIRECTION

1. A touch panel, comprising:
a first electrode which is formed by a plurality of first electrode rows which are formed by a plurality of first unit electrodes including a plurality of grids formed by wiring formed of fine metal wires being connected in a first direction, the first electrode rows being arranged in a second direction orthogonal to the first direction at a predetermined interval; and
a second electrode which is electrically isolated from the first electrode and is formed by a plurality of second electrode rows which are formed by a plurality of second unit electrodes including the plurality of grids being connected in the second direction, the second electrode rows being arranged in the first direction at a predetermined interval,
wherein the first electrode and the second electrode are disposed such that the electrodes of one of the first unit electrodes and the second unit electrodes are surrounded by the electrodes of the other in plan view, and
wherein a shape of the grid is formed such that a difference in transmittance between the plurality of grids is less than or equal to 1%, and, the wiring in the plurality of grids includes at least a portion formed at a first cycle interval and a portion formed at a second cycle interval that differs from the first cycle interval.

2. The touch panel according to claim 1,
wherein the plurality of grids are formed in a polygonal shape other than a regular polygonal shape.

3. The touch panel according to claim 1,
wherein the plurality of grids include a plurality of grids of different shapes.

4. The touch panel according to claim 1,
wherein the plurality of grids are formed of grids of the same shape.

5. The touch panel according to claim 1,
wherein a first connecting portion which connects the plurality of first unit electrodes to each other is provided in the first electrode row,
wherein a second connecting portion which connects the plurality of second unit electrodes to each other is provided in the second electrode row,
wherein the first connecting portion and the second connecting portion are formed to interpose an insulating layer, and
wherein the shape of the grid is formed at a portion at which the first connecting portion and the second connecting portion overlap in plan view.

6. The touch panel according to claim 1,
wherein the shape of the grid is a rectangle.

7. The touch panel according to claim 1,
wherein the shape of the grid is an L-shaped hexagon.

8. The touch panel according to claim 1,
wherein the shape of the grid is an x-shaped dodecagon.

9. The touch panel according to claim 1,
wherein the shape of the grid is a T-shaped octagon.

10. The touch panel according to claim 1,
wherein a difference in transmittance between the plurality of grids is less than or equal to 0.5%.

11. The touch panel according to claim 1,
wherein a wiring portion formed at the first cycle interval is formed such that contrast sensitivity is lower than a wiring portion formed at the second cycle interval.

12. The touch panel according to claim 11,
wherein a length of a wiring portion formed at the first cycle interval is formed such that a spatial frequency, which is a number of stripes per 1 degree of visual angle at a visual distance of 300 mm, is greater than or equal to 9 cycle/deg.

13. A display device, comprising:
the touch panel according to claim 1.
